(19) United States
(12) Patent Application Publication
(10) Pub. No.: US 2011/0227895 A1
(43) Pub. Date: Sep. 22, 2011

(54) BACKLIGHT UNIT, ILLUMINATION DEVICE, AND DISPLAY DEVICE

(76) Inventors: Kiyoshi Takahashi, Kyoto (JP); Takeshi Arakawa, Kyoto (JP); Ryo Minamihata, Osaka (JP)

(21) Appl. No.: 13/029,034

(22) Filed: Feb. 16, 2011

(30) Foreign Application Priority Data
Feb. 16, 2010 (JP) 2010-031429
Feb. 16, 2011 (JP) 2011-030367

(51) Int. Cl. G09G 3/36; F21V 8/00; G06F 3/038

(52) U.S. Cl. 345/211; 362/613; 345/102

(57) ABSTRACT

Backlight unit (10), illumination device (400) and display device (1) capable of local dimming control while achieving high contrast are provided. Backlight unit (10) includes light guide plate (100), which includes layered plate-like optical members (110, 120), and light sources (12). A main surface (111, 121) of each optical member (110, 120) is partitioned into areas including one or more emergence areas and non-emergence areas. When light is incident on each optical member (110, 120) through a side surface thereof, light emerges from emergence areas but does not emerge from non-emergence areas. The optical members (110, 120) are layered such that each non-emergence area of one optical member (110) overlaps a different one of emergence areas of another (120). Light sources (12) are arranged to face the side surface of each optical member (110, 120) and are capable of local dimming control by being lit with light emitted therefrom adjusted.

This application is based on applications No. 2010-31429 and No. 2011-030367 filed in Japan, the contents of which are hereby incorporated by reference.

### TECHNICAL FIELD

The present invention relates to a backlight unit, an illumination device and a display device that can perform local dimming control.

### BACKGROUND ART

Heretofore, there has been a suggestion to reduce power consumption and improve the contrast of a display device having a liquid crystal panel. More specifically, the suggestion includes adjusting the brightness of each area of the backlight unit—i.e., adjusting light on a per-area basis (namely, local dimming control)—in synchronization with the brightness of a corresponding area of an image displayed on the liquid crystal panel.

FIGS. 24A to 25B are schematic diagrams each showing a main structure of a conventional display device capable of local dimming control. Each of FIGS. 24A and 25A is a side view of a liquid crystal panel as well as a light guide plate and light sources of a backlight unit. Each of FIGS. 24B and 25B is a rear view of the liquid crystal panel as well as the light guide plate and light sources of the backlight unit.

As shown in FIGS. 24A and 24B, a backlight unit 501 of the display device pertaining to Patent Literature 1 includes a light guide plate 503 on which a plurality of optical members 502 are arranged in a matrix (i.e., in row and column directions). Each optical member 502 increases in thickness toward one direction and therefore has a substantially triangular cross-section. Light sources 504 are each arranged so as to face a side surface of the corresponding optical member 502 having the largest thickness.

On the other hand, as shown in FIGS. 25A and 25B, a backlight unit 601 of the display device pertaining to Patent Literature 2 includes a light guide plate 603 that is partitioned into a plurality of areas by a grid-like groove 602 extending in row and column directions. Light sources 604 are arranged in one-to-one correspondence with the areas so as to the opposing side surfaces of the light guide plate 603.

These backlight units 501 and 601 can adjust light from each area of the light guide plates 503 and 603 by adjusting the luminous intensity of a correspond one of the light sources 504 and 604. With the backlight units 501 and 601 positioned behind the liquid crystal panels 505 and 605, the local dimming control is made possible by switching among lighting operations on the light sources 504 and 604 in synchronization with the timing to supply image signals to the liquid crystal panels 505 and 605.

### CITATION LIST

### Patent Literature

### [Patent Literature 1]

JP Patent Application Publication No. 2009-193892

### [Patent Literature 2]

JP Patent Application Publication No. 2008-34372

### SUMMARY OF INVENTION

### Technical Problem

However, the above-described backlight units 501 and 601 both give rise to the following problem. When the local dimming control is performed to light only a certain area, light from the mentioned area leaks to other areas neighboring in the mentioned area in row and column directions; as a result, the outer perimeter of the target area becomes blurry, thus lowering the contrast of the display device. For example, in the case of the backlight unit 501 pertaining to Patent Literature 1, side surfaces of each optical member 502 are in surface contact with side surfaces of other optical members neighboring in row and column directions. That is to say, light from each optical member 502 leaks to other neighboring optical members through its side surfaces. Similarly, in the case of the backlight unit 601 pertaining to Patent Literature 2, although the groove 602 optically separates the areas from one another to some extent, light from each area leaks to other areas neighboring in row and column directions via connecting portions, which exist beneath the bottom of the groove 602 to connect between the areas, or via an air space within the groove 602.

In view of the above problem, the present invention aims to provide a backlight unit, an illumination device and a display device that can perform local dimming control while preserving high contrast.

### Solution to Problem

In order to achieve the above aim, one aspect of the backlight unit pertaining to the present invention is as follows. The backlight unit includes a light guide plate and a plurality of light sources, wherein (i) the light guide plate includes a plurality of layered plate-like optical members, (ii) a main surface of each optical member is partitioned into a plurality of areas that include one or more emergence areas and one or more non-emergence areas, (iii) when light is incident on each optical member through a side surface thereof, the incident light emerges from the emergence areas of the optical member but does not emerge from any of the non-emergence areas of the optical member, (iv) the optical members are layered in such a manner that each non-emergence area of one of the optical members overlaps a different one of the emergence areas of another optical member, and (v) the light sources are arranged so as to face the side surface of each optical member and are capable of local dimming control by being lit with light emitted therefrom adjusted.

Another aspect of the backlight unit pertaining to the present invention is as follows. The backlight unit comprises a light guide plate that includes a plurality of plate-like optical members layered in a thickness direction of the optical members and that has (i) one or more side surfaces through which light is incident on the light guide plate and (ii) a main surface from which the incident light emerges. In the backlight unit, (i) side surfaces of the optical members constituting the one or more side surfaces of the light guide plate are light incident surfaces through which the light is incident on the optical members, (ii) a plurality of light sources are arranged so as to face the light incident surfaces, (iii) a main surface of each optical member that either constitutes the main surface of the light guide plate or is closer to the main surface of the light guide plate than any other surfaces of the optical member includes one or more emergence areas and one or more non-emergence areas, (iv) light emitted from the light sources and incident on the optical members through the light incident surfaces emerges from the emergence areas but does not emerge from any of the non-emergence areas, and (v) when viewing the light guide plate while facing the main surface thereof, each emergence area of one of the optical members does not overlap any of the emergence areas of another optical member, and each non-emergence area of one of the optical members overlaps a different one of the emergence areas of another optical member.

One aspect of the display device pertaining to the present invention is as follows. The display device comprises: the above-described backlight unit; a liquid crystal panel illuminated by the backlight unit; and a control unit configured to supply image signals to the liquid crystal panel and to light one or more of the light sources in accordance with one or more positions on a screen and luminance of each position, which are indicated by the image signals, while adjusting light emitted from the one or more of the light sources in synchronization with a timing to display an image.

One aspect of the illumination device pertaining to the present invention is as follows. The illumination device includes a light guide plate and a plurality of light sources, wherein (i) the light guide plate includes a plurality of layered plate-like optical members, (ii) a main surface of each optical member is partitioned into a plurality of areas that include one or more emergence areas and one or more non-emergence areas, (iii) when light is incident on each optical member through a side surface thereof, the incident light emerges from the emergence areas of the optical member but does not emerge from any of the non-emergence areas of the optical member, (iv) the optical members are layered in such a manner that each non-emergence area of one of the optical members overlaps a different one of the emergence areas of another optical member, and (v) the light sources are arranged so as to face the side surface of each optical member.

Another aspect of the illumination device pertaining to the present invention is as follows. The illumination device comprises a light guide plate that includes a plurality of plate-like optical members layered in a thickness direction of the optical members and that has (i) one or more side surfaces through which light is incident on the light guide plate and (ii) a main surface from which the incident light emerges. In the illumination device, (i) side surfaces of the optical members constituting the one or more side surfaces of the light guide plate are light incident surfaces through which the light is incident on the optical members, (ii) a plurality of light sources are arranged so as to face the light incident surfaces, (iii) a main surface of each optical member that either constitutes the main surface of the light guide plate or is closer to the main surface of the light guide plate than any other surfaces of the optical member includes one or more emergence areas and one or more non-emergence areas, (iv) light emitted from the light sources and incident on the optical members through the light incident surfaces emerges from the emergence areas but does not emerge from any of the non-emergence areas, and (v) when viewing the light guide plate while facing the main surface thereof, each emergence area of one of the optical members does not overlap any of the emergence areas of another optical member, and each non-emergence area of one of the optical members overlaps a different one of the emergence areas of another optical member.

Another aspect of the display device pertaining to the present invention is as follows. A display device comprises: the above-described illumination device; a sign board that includes a plurality of sign regions and is illuminated by the illumination device; and a control unit configured to light one or more of the light sources in accordance with the sign regions.

### Advantageous Effects of Invention

The backlight unit, illumination device and display device pertaining to the present invention are configured in the above-described manner. Accordingly, if two emergence areas neighbor each other when viewing the light guide plate while facing the light emergence surface thereof but belong to different optical members, then light leakage rarely occurs between these two emergence areas. Therefore, it is unlikely for the outer perimeters of these two emergence areas to become blurry, and the local dimming control can be performed while preserving high contrast.

### BRIEF DESCRIPTION OF DRAWINGS

FIG. 1 is a cross-sectional view showing a schematic structure of a backlight unit and a display device pertaining to First Embodiment.

FIG. 2 is an exploded perspective view showing a light guide plate.

FIG. 3 is a perspective view illustrating aspects of dotted patterns formed on optical members.

FIG. 4 is a schematic diagram illustrating paths through which light incident on the optical members propagates.

FIG. 5 is a schematic diagram illustrating how positions of grooves affect luminance distribution.

FIG. 6 is a perspective view illustrating the arrangement of light sources in relation to optical members.

FIG. 7 is a schematic diagram illustrating the local dimming control performed by a control unit.

FIG. 8 is a schematic diagram showing a modification example in which the reflecting sheets are arranged on areas that oppose the emergence areas.

FIG. 9 is a schematic diagram showing a modification example in which the grooves do not overlap one another.

FIG. 10 is a schematic diagram showing a modification example in which a diffusion sheet is arranged between the optical members.

FIGS. 11A to 11F are perspective views illustrating shapes of the grooves.

FIGS. 12A to 12C are perspective views illustrating shapes of the grooves.

FIG. 13 is a schematic diagram showing a modification example of the positions in which the grooves are formed.

FIG. 14 is a schematic diagram showing another modification example of the positions in which the grooves are formed.

FIG. 15 is a schematic diagram showing yet another modification example of the positions in which the grooves are formed.

FIG. 16 is a schematic diagram showing yet another modification example of the positions in which the grooves are formed.

FIGS. 17A and 17B are schematic diagrams showing a modification example of arrangements of emergence areas and non-emergence areas.

FIGS. 18A and 18B are schematic diagrams showing another modification example of arrangements of emergence areas and non-emergence areas.

FIGS. 19A and 19B are schematic diagrams showing yet another modification example of arrangements of emergence areas and non-emergence areas.

FIGS. 20A to 20C are schematic diagrams showing a modification example of a light guide plate including three optical members.

FIGS. 21A and 21B are schematic diagrams showing a modification example applicable to a case where the direction that a light incidence surface faces differs from one optical member to another.

FIGS. 22A to 22C are schematic diagrams showing another modification example applicable to a case where the direction that s light incidence surface faces differs from one optical member to another.

FIG. 23 is a partially cutaway perspective view showing a schematic structure of an illumination device and a display device pertaining to Second Embodiment.

FIGS. 24A and 24B are schematic diagrams each showing the structure of main components of a conventional display device capable of local dimming control.

FIGS. 25A and 25B are schematic diagrams each showing the structure of main components of a conventional display device capable of local dimming control.

### DESCRIPTION OF EMBODIMENTS

The following describes a backlight unit, an illumination device and a display device pertaining to embodiments of the present invention with reference to the accompanying drawings.

### First Embodiment

A description is now given of a backlight unit pertaining to First Embodiment and of a display device using the same.

### (Display Device)

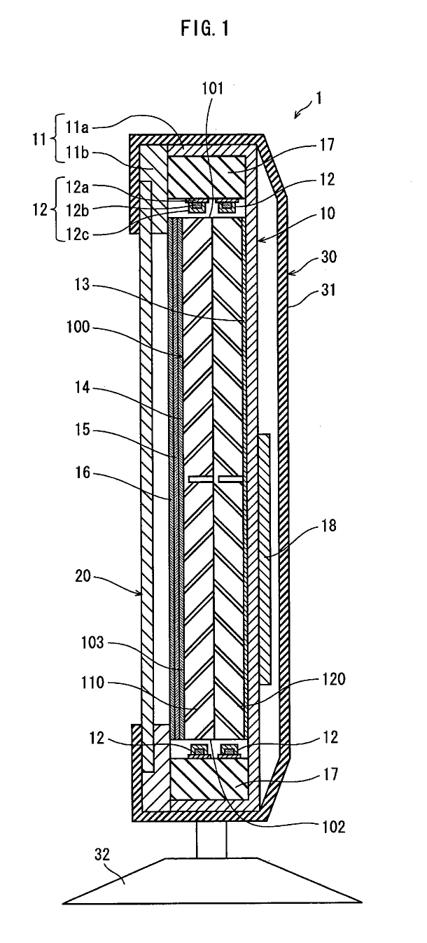

FIG. 1 is a cross-sectional diagram showing a schematic structure of the display device pertaining to the present embodiment. As shown in FIG. 1, a display device 1 pertaining to the present embodiment is a liquid crystal display device, and is composed of an edge-lit backlight unit 10, an active-matrix liquid crystal panel 20, a housing 30, and the like. The backlight unit 10 illuminates the liquid crystal panel 20. The housing 30 houses the backlight unit 10, the liquid crystal panel 20, and the like.

### (Backlight Unit)

The backlight unit 10 is composed of a light guide plate 100, a housing 11, LED modules 12 serving as examples of light sources, a reflecting plate 13, a diffusion sheet 14, a prism sheet 15, a polarization sheet 16, heat sinks 17, a control unit 18, and the like. Here, there are twenty-four LED modules 12 in total. Hereinafter, the LED modules 12 are referred to as LED modules 12A₁ to 12L₁ and 12A₂ to 12L₂ when it is necessary to explain them on an individual basis.

### (Light Guide Plate)

### <1. Schematic Structure>

The light guide plate 100 has a shape of a flat rectangular plate. A pair of opposing side surfaces of the light guide plate 100 (i.e., a top side surface and a bottom side surface of the light guide plate 100 in FIG. 1) is light incidence surfaces 101 and 102 on which light is incident. A front main surface of the light guide plate 100 that is close to the liquid crystal panel 20 is a light emergence surface 103 from which the incident light emerges. The light guide plate 100 is formed by layering a plate-like first optical member 110 and a similarly plate-like second optical member 120 in a thickness direction of the first and second optical members 110 and 120.

Each of the first optical member 110 and the second optical member 120 is made of transparent resin with high light transmittance, and has a shape of a flat rectangular plate. Examples of such transparent resin include polycarbonate resin, methacrylate resin, acrylic resin, polyester resin, and cyclic polyolefin resin.

### <2. Optical Members>

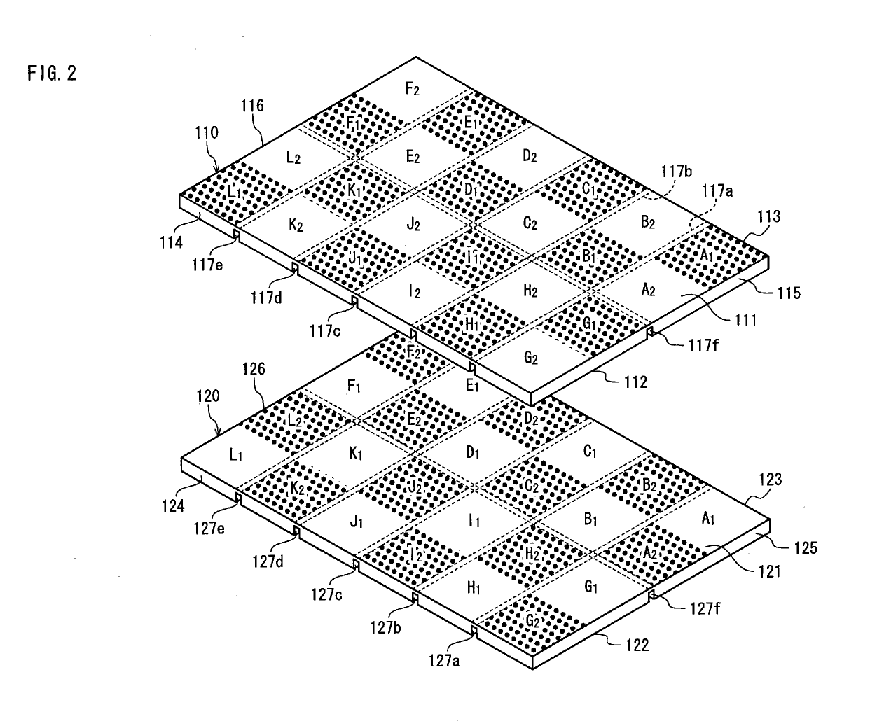

FIG. 2 is an exploded perspective view of the light guide plate. As shown in FIG. 2, the first optical member 110 has a front main surface 111, a back main surface 112, a top side surface 113, a bottom side surface 114, a right side surface 115, and a left side surface 116. The front main surface 111 is a main surface close to the liquid crystal panel 20, and is equivalent to the light emergence surface 103 of the light guide plate 100. The back main surface 112 is in surface contact with the second optical member 120. The top side surface 113 forms a part of the light incidence surface 101 of the light guide plate 100. That is, the top side surface 113 serves as a surface of the first optical member 110 on which light is incident. The bottom side surface 114 forms a part of the light incidence surface 102 of the light guide plate 100. That is, the bottom side surface 114 serves as a surface of the first optical member 110 on which light is incident. The right side surface 115 and the left side surface 116 are light reflecting surfaces for preventing leakage of the light from the first optical member 110 to the outside.

The second optical member 120 has a front main surface 121, a back main surface 122, a top side surface 123, a bottom side surface 124, a right side surface 125, and a left side surface 126. The front main surface 121 is a main surface close to the liquid crystal panel 20, and is in surface contact with the back main surface 112 of the first optical member 110. The back main surface 122 is equivalent to a main surface of the light guide plate 100 opposite to the light emergence surface 103 of the light guide plate 100. The top side surface 123 forms a part of the light incidence surface 101 of the light guide plate 100. That is, the top side surface 123 serves as a surface of the second optical member 120 on which light is incident. The bottom side surface 124 forms a part of the light incidence surface 102 of the light guide plate 100. That is, the bottom side surface 124 serves as a surface of the second optical member 120 on which light is incident. The right side surface 125 and the left side surface 126 are light reflecting surfaces for preventing leakage of the light from the second optical member 120 to the outside.

### <3. Arrangement of Emergence Areas and Non-Emergence Areas>

The front main surface 111 of the first optical member 110 has a plurality of emergence areas and a plurality of non-emergence areas. More specifically, the front main surface 111 is partitioned into six areas in a direction parallel to the light incidence surface 101 of the light guide plate 100 (i.e., a row direction), and into four areas in a direction perpendicular to the light incidence surface 101 of the light guide plate 100 (i.e., a column direction). In other words, the front main surface 111 is partitioned into twenty-four areas in a matrix (i.e., in row and column directions) as a whole.

Each of the twenty-four partitioned areas is one of an emergence area and a non-emergence area. Referring to the front main surface 111 of the first optical member 110 shown in FIG. 2, hatched areas A₁ to L₁ are emergence areas, whereas non-hatched areas A₂ to L₂ are non-emergence areas. These emergence areas and non-emergence areas are arranged in a checkerboard pattern. More specifically, each emergence area is not neighboring any other emergence area in both row and column directions. Similarly, each non-emergence area is not neighboring any other non-emergence area in both row and column directions.

The front main surface 121 of the second optical member 120 also has a plurality of emergence areas and a plurality of non-emergence areas. To be more specific, as with the first optical member 110, the front main surface 121 is partitioned into six areas in a row direction, and into four areas in a column direction. In other words, the front main surface 121 is partitioned into twenty-four areas in a matrix (i.e., in row and column directions) as a whole.

Each of the twenty-four partitioned areas of the front main surface 121 is also one of an emergence area and a non-emergence area. Referring to the front main surface 121 shown in FIG. 2, hatched areas A₂ to L₂ are emergence areas, whereas non-hatched areas A₁ to L₁ are non-emergence areas. These emergence areas and non-emergence areas are arranged in a checkerboard pattern that is the reverse of the checkerboard pattern of the first optical member 110. More specifically, each emergence area is not neighboring any other emergence area in both row and column directions. Similarly, each non-emergence area is not neighboring any other non-emergence area in both row and column directions.

Assume that the light guide plate 100 has been set up by layering the first optical member 110 and the second optical member 120. Here, when viewing the light guide plate 100 while facing the light emergence surface 103 thereof, each emergence area of the first optical member 110 overlaps a different one of the non-emergence areas of the second optical member 120. In a similar manner, each non-emergence area of the first optical member 110 overlaps a different one of the emergence areas of the second optical member 120. Put another way, each emergence area of the first optical member 110 overlaps none of the emergence areas of the second optical member 120, and each non-emergence area of the first optical member 110 overlaps none of the non-emergence areas of the second optical member 120.

As set forth above, a positional relationship between emergence areas and non-emergence areas of the first optical member 110 is the exact reverse of that of the second optical member 120. When viewing the light guide plate 100 while facing the light emergence surface 103 thereof, each emergence area of the optical members 110 and 120 is contiguously neighboring other emergence areas in row and column directions. Thus, the emergence areas of the optical members 110 and 120 altogether cover an entirety of the light emergence surface 103 of the light guide plate 100.

Meanwhile, when taking a look at a single individual optical member, whether it be the first optical member 110 or the second optical member 120, each emergence area is not neighboring any other emergence area in row and column directions. The first optical member 110 and the second optical member 120 are configured so that each emergence area of one of the optical members 110 and 120 neighbors emergence areas of the other in row and column directions. Accordingly, although each emergence area of the optical members 110 and 120 neighbors other emergence areas in row and column directions when viewing the light guide plate 100 while facing the light emergence surface 103 thereof, all the emergence areas are in fact optically separated from one another.

Note that the row-direction widths and column-direction widths of emergence areas and non-emergence areas may be selected arbitrarily for each of the optical members 110 and 120.

<4. Configuration for Partitioning into Emergence Areas and Non-emergence Areas>

Described below is the configuration for partitioning the front main surfaces 111 and 121 of the optical members 110 and 120 into emergence areas and non-emergence areas.

First of all, it should be noted that the emergence areas on the front main surface 111 of the first optical member 110 denote areas from which the light incident on the top side surface 113 or the bottom side surface 114 emerges, whereas the non-emergence areas on the front main surface 111 of the first optical member 110 denote areas from which the stated light does not emerge. Certain positions of the first optical member 110 that correspond to the emergence areas have been subjected to processing that allows the light incident on the top side surface 113 or the bottom side surface 114 to emerge from the emergence areas.

Similarly, it should also be noted that the emergence areas on the front main surface 121 of the second optical member 120 denote areas from which the light incident on the top side surface 123 or the bottom side surface 124 emerges, whereas the non-emergence areas on the front main surface 121 of the second optical member 120 denote areas from which the stated light does not emerge. As with the first optical member 110, certain positions of the second optical member 120 that correspond to the emergence areas have been subjected to processing that allows the light incident on the top side surface 123 or the bottom side surface 124 to emerge from the emergence areas.

The above-mentioned processing that allows the incident light to emerge from the emergence areas denotes processing to provide light collecting elements for causing the light emitted from the LED modules 12 to exit the optical members 110 and 120. The following are the examples of the light collecting elements: a light scattering element (e.g., a light scattering structure), such as a dotted pattern formed on the surfaces of the optical members 110 and 120 by printing, molding, or the like; a prism-like element formed on the surface of the light guide plate; and a light scattering element formed inside the optical members 110 and 120.

In the present embodiment, as one specific example of the above-mentioned processing, dotted patterns are formed on areas of the back main surfaces 112 and 122 of the optical members 110 and 120 that correspond to the emergence areas. The dotted patterns are not formed on areas of the back main surfaces 112 and 122 that correspond to the non-emergence areas. The above configuration partitions each of the front main surfaces 111 and 121 into emergence areas and non-emergence areas.

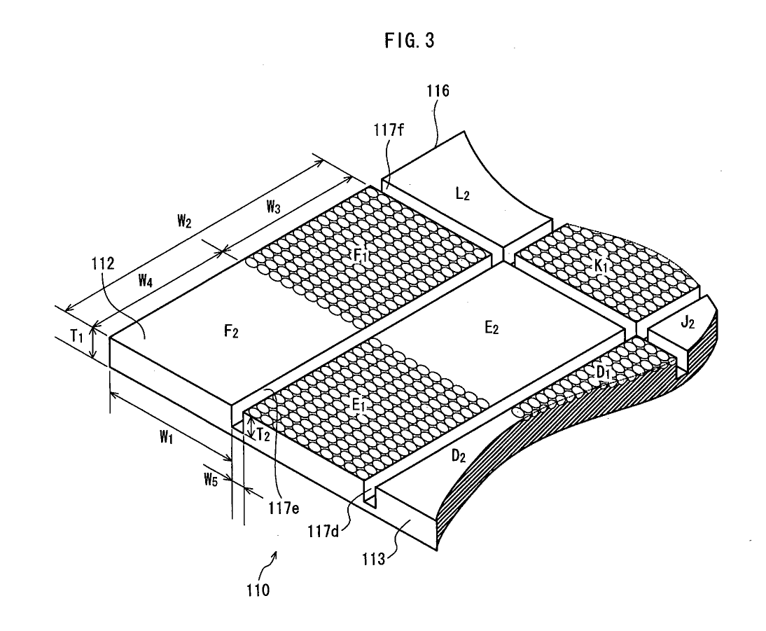

FIG. 3 is a perspective view illustrating aspects of dotted patterns formed on each optical member. For example, as shown in FIG. 3, a dotted pattern is formed on an area of the back main surface 112 of the first optical member 110 that opposes the emergence area F₁ of the front main surface 111. On the other hand, a dotted pattern is not formed on an area of the back main surface 112 that opposes the non-emergence area F₂ of the front main surface 111. Each of the dots included in the dotted patterns is a substantially hemispheric concave. It should be noted here that each of the concaves forming the dots is not limited to having a substantially hemispheric cross-section. A cross-section of each concave may have a shape of a substantial semi-ellipsoid, a substantial circular cone, a substantial conical frustum, a substantial circular cylinder, a substantial pyramid, a substantial polygonal column, etc. Although the dotted patterns pertaining to the present embodiment include concaves formed by denting portions of the surfaces of the optical members 110 and 120 toward the inside of the optical members 110 and 120, the dotted patterns are not limited to including such concaves. Alternatively, for example, it is permissible to print ink having light diffusing properties on the surfaces of the optical members 110 and 120 so as to form thereon dotted patterns including convexes that protrude outward.

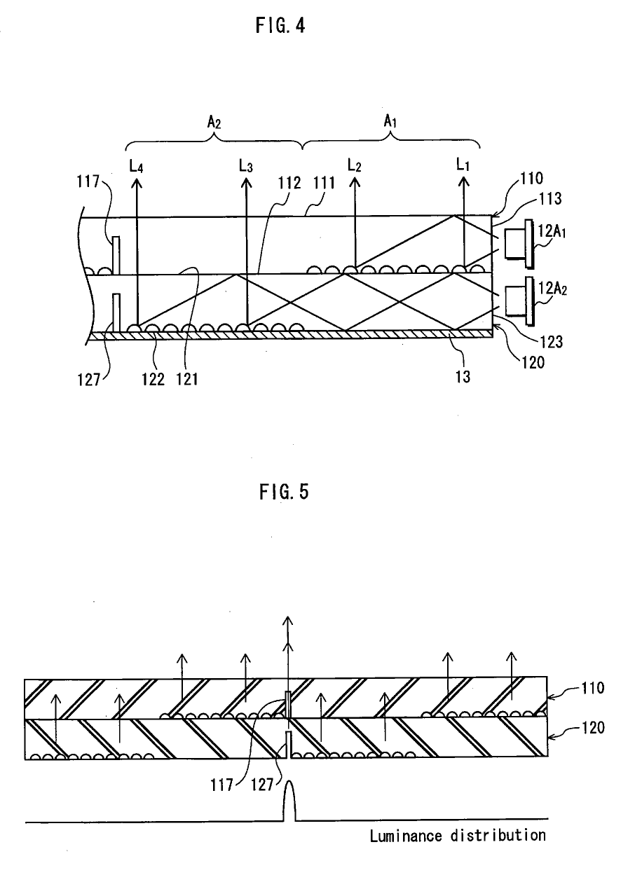

FIG. 4 is a schematic diagram illustrating paths through which light incident on the optical members propagates. For example, as shown in FIG. 4, the light emitted from the LED module 12A₁ enters the first optical member 110 through the top side surface 113 thereof, and propagates inside the first optical member 110 toward directions away from the LED module 12A₁ while undergoing total internal reflection at the front main surface 111 and the back main surface 112. Here, when the light is scattered by the dotted pattern formed on an area of the back main surface 112 that opposes the emergence area A₁ of the front main surface 111, the light no longer satisfies conditions for total internal reflection and therefore emerges from the emergence area A₁ of the front main surface 111 toward the outside of the optical member 110 (propagation paths L₁ and L₂).

In contrast, in an area of the back main surface 112 that opposes the non-emergence area A₂, on which no dotted pattern is formed, the light emitted from the LED module 12A₁ is not scattered and therefore never fails to satisfy the conditions for total internal reflection. As a result, the light does not emerge from the non-emergence area A₂ of the front main surface 111. Here, there is a possibility that part of the light scattered by the dotted pattern formed on the area of the back main surface 112 opposing the emergence area A₁ emerges from a portion of the non-emergence area A₂ located in the vicinity of the border between the non-emergence area A₂ and the emergence area A₁. However, even so, this is not considered as a light leakage problem because the quantity of the part of the light emerging from such a portion of the non-emergence area A₂ is so minute that it is difficult to visually recognize the same.

Distribution of the quantity of light emerging from each emergence area is optimally designed by controlling the extent of light scattering by way of adjustment of all of or any combination of the size, shape and density of the dots. More specifically, an entirety of the light emitted from the LED module 12A₁ and incident on the first optical member 110 is designed to emerge from the emergence area A₁ of the first optical member 110. This way, the light emitted from the LED module 12A₁ is prevented from proceeding past the emergence area A₁ downstream along the travelling direction of the light and emerging from another emergence area (specifically, the emergence area G₁; see FIG. 2). In addition, each emergence area is designed so that the size of each dot in the corresponding dotted pattern becomes larger, or the depth of the dent of each dot in the corresponding dotted pattern becomes larger, toward the downstream end of the travelling direction of the light. This design increases the extent of light scattering and allows the light to emerge evenly from an entirety of the emergence area A₁.

It should be noted that the dotted patterns can be formed by such methods as molding (e.g., injection molding), screen printing, laser processing, etc. Any of these methods enables formation of dots having optimal size, shape and density.

The light emitted from the LED module 12A₂ enters the second optical member 120 through the top side surface 123 thereof, and propagates inside the second optical member 120 toward directions away from the LED module 12A₂ while undergoing total internal reflection at the front main surface 121 and the back main surface 122. Here, the light is scattered by the dotted pattern formed on an area of the back main surface 122 that opposes the emergence area A₂ of the front main surface 121, and then emerges from the emergence area A₂ of the front main surface 121 toward the outside of the second optical member 120. The light that has exited the second optical member 120 is incident on the first optical member 110 through the back main surface 112 thereof. Thereafter, this incident light passes through the inside of the first optical member 110 and emerges from the front main surface 111 of the first optical member 110 toward the outside of the first optical member 110 (propagation paths L₃ and L₄).

As has been described above, the light incident on the second optical member 120 is transmitted through the first optical member 110 and emerges from the front main surface 111 of the first optical member 110. It rarely emerges from the top side surface 123 and the bottom side surface 124 of the second optical member 120.

According to the above-described present embodiment, in order to partition the front main surfaces 111 and 121 of the optical members 110 and 120 into emergence areas and non-emergence areas, the dotted patterns are formed on areas of the back main surfaces 112 and 122 of the optical members 110 and 120 that oppose the emergence areas of the front main surfaces 111 and 121. However, the dotted patterns are not limited to being formed on the back main surfaces 112 and 122 of the optical members 110 and 120, but may instead be formed on the front main surfaces 111 and 121, or on both of the front main surfaces 111 and 121 and the back main surfaces 112 and 122. It should be noted here that the dotted patterns are more unlikely to cast shadow when formed on the back main surfaces 112 and 122.

The front main surfaces 111 and 121 may be partitioned into emergence areas and non-emergence areas by using methods other than formation of the dotted patterns. For example, such partitioning may be done by arranging light collecting elements for diffusing the light (e.g., minuscule prisms and grooves) on areas corresponding to the emergence areas of the optical members 110 and 120. In a case where the grooves are formed, an optical design that can realize both light collection and light diffusion is possible by narrowing both the pitch distance between the grooves and the width of each groove. Alternatively, the front main surfaces 111 and 121 may be partitioned into emergence areas and non-emergence areas by forming light collecting elements (e.g., minuscule lenses and minuscule prisms) for focusing the light or changing the travelling path of the light on areas corresponding to the emergence areas of the optical members 110 and 120.

### <5. Grooves>

As shown in FIG. 2, a total of six grooves 117 (127) are formed on the back main surface 112 (122) of the optical member 110 (120). More specifically, five grooves extend in a column direction and one groove extends in a row direction on the back main surface 112 (122). Note that in FIG. 2, the grooves 117 (127) extending in the column direction are respectively assigned reference numbers “117a” to “117e” (“127a” to “127e”) from the right in series, whereas the groove 117 (127) extending in the row direction is assigned the reference number “117f” (“127f”) as necessary.

Each of the grooves 117 (127) is formed in a position that is equivalent to a border between an emergence area and a non-emergence area. However, it should be mentioned that a groove 117 (127) is not formed in every position that is equivalent to a border between an emergence area and a non-emergence area. As shown in FIG. 3, the optical member 110 (120) is partitioned into rectangular regions by the grooves 117 (127), each rectangular region having a row-direction width W₁ of 116 mm and a column-direction width W₂ of 137 mm. Each rectangular region is made up of one emergence area and one non-emergence area arranged in a column direction. A column-direction width W₃ of this emergence area is the same as a column-direction width W₄ of this non-emergence area. Note that this is the case of a 37-inch television screen.

The optical member 110 (120) has a thickness T₁ of 4 mm, and each of the grooves 117 (127) has a depth T₂ of 3.5 mm. That is to say, the grooves 117 (127) do not penetrate through the optical member 110 (120) in a thickness direction of the optical member 110 (120). It is preferable that a ratio of the depth T₂ to the thickness T₁ (T₂/T₁) satisfy the following relationship: 0.5≦T₂/T₁≦0.95. When the ratio of the depth T₂ to the thickness T₁ is greater than 0.95, a thickness of a connecting portion of the optical member 110 (120) that connects between two regions neighboring with a groove 117 (127) therebetween becomes extremely small. This leads to a concern that the strength of connection between such two neighboring regions—i.e., the strength of the optical member 110 (120)—may be lowered. In contrast, when the ratio of the depth T₂ to the thickness T₁ is smaller than 0.5, the thickness of such a connection portion of the optical member 110 (120) that connects between two neighboring regions becomes extremely large. This attenuates the shielding performance of the grooves 117 (127), and as a result, light emerging from a certain region leaks to other regions neighboring in row and column directions, and the outer perimeter of the target region becomes blurry. Consequently, a concern is raised that the contrast of the display device 1 may be lowered. Accordingly, in order to prevent leakage of light to other neighboring regions while retaining the strength of the optical member 110 (120), it is preferable to adjust the ratio of the thickness T₂ to the thickness T₁ to fall within the above-mentioned range.

Each of the grooves 117 (127) has a width W₅ of 1 mm. It is preferable that a ratio of the width W₅ to the width W₁ (W₅/W₁) be smaller than or equal to 0.1. It is also preferable that a ratio of the width W₅ to the width W₂ (W₅/W₂) be smaller than or equal to 0.1. When W₅/W₁ and W₅/W₂ exceed 0.05, the area of a border between an emergence area and a non-emergence area becomes large, and the contrast may be lowered upon performing the local dimming. Thus, it is not preferable for W₅/W₁ and W₅/W₂ to exceed 0.05.

As shown in FIG. 2, the five grooves 117a to 117e (127a to 127e) extending in the column direction are formed so as to extend all the way from the top side surface 113 (123) to the bottom side surface 114 (124) opposing the top side surface 113 (123) in a direction perpendicular to the top side surface 113 (123). Similarly, one groove 117f (127f) extending in the row direction is formed so as to extend all the way from the right side surface 115 (125) to the left side surface 116 (126) opposing the right side surface 115 (125) in a direction perpendicular to the right side surface 115 (125).

Since an air space exists within each groove 117 (127), the light travelling inside the optical member 110 (120) reflects off the side surfaces of the grooves 117 (127)—i.e., the interfaces between the optical member 110 (120) and the air space—upon hitting each groove 117 (127). As such, the emergence areas are optically separated from the non-emergence areas also by the grooves 117 (127). It should be noted that by making the width W₅ of each groove 117 (127) larger than the wavelength of the light emitted from the LED modules 12, two areas neighboring with any groove 117 (127) therebetween can be optically separated from each other in a more reliable manner.

The above-described grooves 117 (127) can be formed by, for example, injection molding the light guide plate 100 or etching the light guide plate 100.

FIG. 5 is a schematic diagram illustrating how positions of the grooves affect luminance distribution. As shown in FIG. 5, the grooves 117 of the first optical member 110 and the grooves 127 of the second optical member 120 are formed in such a manner that, when viewing the light guide plate 100 while facing the light emergence surface 103, each groove 117 overlaps a different one of the grooves 127. Light emerging from portions of the optical members 110 and 120 in which the grooves 117 and 127 are formed tend to have higher luminance than light emerging from portions of the optical members 110 and 120 in which the grooves 117 and 127 are not formed. By thus having each groove 117 overlap a different one of the grooves 127 in the above-described manner, the widths of portions from which light having high luminance emerges can be narrowed.

### (Housing)

Referring back to FIG. 1, the housing 11 is made of metal (e.g., zinc-plated steel), and includes a box-shaped housing body 11a having a mouth located at the front and a substantially quadrilateral front frame 11b attached to the front side of the housing body 11a. The reflecting plate 13, the light guide plate 100, the diffusion sheet 14, the prism sheet 15, and the polarization sheet 16 are layered inside the housing 11 in the stated order, with the reflecting plate 13 positioned on the inner bottom surface of the housing body 11a. In addition, inside the housing 11, a plurality of LED modules 12 are mounted on the heat sinks 17 while facing the light incidence surfaces 101 and 102 of the light guide plate 100.

### (Light Sources)

Each of the LED modules 12, which serve as light sources, includes a substrate 12a, a plurality of LED elements 12b, and a wavelength conversion member 12c. The substrates 12a are arranged so as to face the light incidence surfaces 101 and 102 of the light guide plate 100. The LED elements 12b are mounted on the substrates 12a. The wavelength conversion members 12c cover and seal the LED elements 12b. The LED modules 12 emit light towards the light incidence surfaces 101 and 102. By way of example, the color of light emitted from the LED modules 12 is white. In this case, the following exemplary configuration is possible: the LED elements 12b are light emitting diodes that emit blue light, and each wavelength conversion member 12c is made by dispersing a mixture of red and green phosphors made of silicon nitride, or YAG phosphors, into silicone resin.

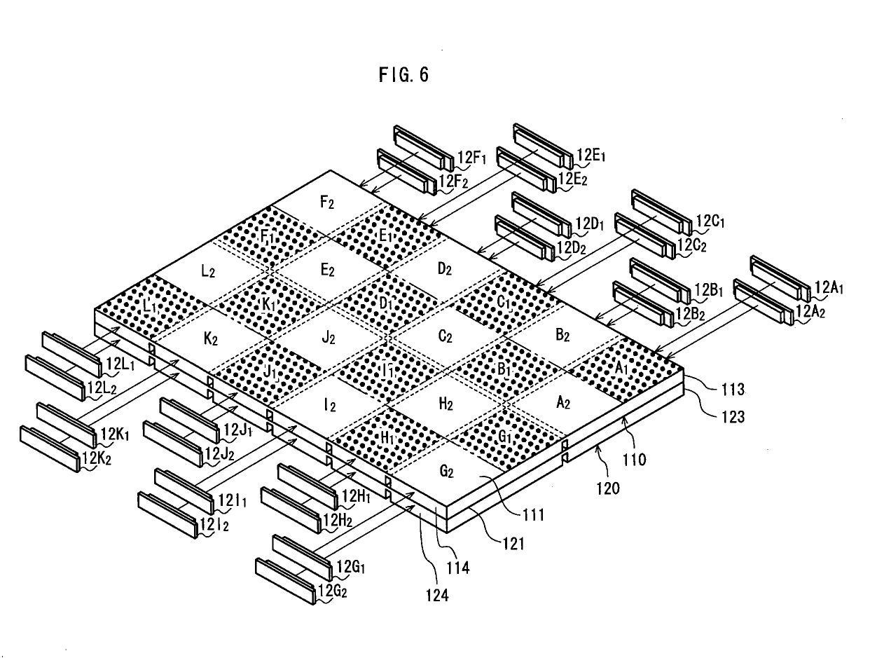

FIG. 6 is a perspective view illustrating the arrangement of light sources in relation to optical members. As shown in FIG. 6, the LED modules 12A₁ to 12L₁ and 12A₂ to 12L₂ are in one-to-one correspondence with the emergence areas A₁ to L₁ and A₂ to L₂. More specifically, the LED modules 12A₁ to 12L₁ and 12A₂ to 12L₂ are arranged so as to face the top side surfaces 113 and 123 and the bottom side surfaces 114 and 124 of the optical members 110 and 120, in one-to-one correspondence with the emergence areas A₁ to L₁ and A₂ to L₂.

To further expound, as for the first optical member 110, the LED modules 12A₁ to 12L₁ are arranged in one-to-one correspondence with the emergence areas A₁ to L₁. For example, the LED module 12A₁ is arranged in correspondence with the emergence area A₁ of the first optical member 110. In a similar manner, as for the second optical member 120, the LED modules 12A₂ to 12L₂ are arranged in one-to-one correspondence with the emergence areas A₂ to L₂ (see FIG. 2).

As shown in FIG. 1, the light emitted from each LED module 12 is incident on the light guide plate 100 through the light incidence surface 101 or 102. The incident light is averaged when transmitted through the light guide plate 100, and emerges from the light emergence surface 103 of the light guide plate 100. Thereafter, the light is transmitted through the diffusion sheet 14, the prism sheet 15 and the polarization sheet 16, and emerges from the opening of the front frame 11b toward the outside of the backlight unit 10. Finally, the light is transmitted through and emerges from the liquid crystal panel 20 toward the outside of the display device 1.

As a result of lighting all of the LED modules 12A₁ to 12L₁ and 12A₂ to 12L₂ shown in FIG. 6, light emerges from the emergence areas A₁ to L₁ of the first optical member 110 and from the emergence areas A₂ to L₂ of the second optical member 120. Consequently, an entirety of the light emergence surface 103 of the light guide plate 100 is lit. Alternatively, the emergence areas A₁ to L₁ and A₂ to L₂ can be lit on an individual basis by lighting the LED modules 12A₁ to 12L₁ and 12A₂ to 12L₂ on an individual basis.

### (Reflecting Plate)

The reflecting plate 13 is a substantially quadrilateral sheet material made of, for example, polyethylene terephthalate (PET), and is arranged on a main surface of the light guide plate 100 that opposes the light emergence surface 103 of the light guide plate 100. The reflecting plate 13 improves luminance by reflecting light that has arrived at this main surface of the light guide plate 100 toward the light emergence surface 103. Alternatively, the reflecting plate 13 may be a metal foil, an Ag sheet, or the like with a metallic luster.

### (Diffusion Sheet)

The diffusion sheet 14 is a substantially quadrilateral film made of, for example, PET or polycarbonate (PC) resin. The diffusion sheet 14 is layered while being substantially adhered to the light emergence surface 103 of the light guide plate 100. By providing this diffusion sheet 14, light emerging from the backlight unit 10 can be averaged in a suitable manner. As a result, the quality of the backlight unit 10 can be improved. In addition, the front luminance can be further enhanced by selectively using an appropriate diffusion sheet 14.

### (Prism Sheet)

The prism sheet 15 is a substantially quadrilateral optical sheet made by forming an acrylic resin prism pattern evenly on one surface of a faceplate made of, for example, polyester resin. The prism sheet 15 is layered while being adhered to the diffusion sheet 14.

### (Polarization Sheet)

The polarization sheet 16 is a substantially quadrilateral film made by joining a PC film, a polyester film and acrylic-based resin, or made of polyethylene naphthalate (PEN). The polarization sheet 16 is layered while being adhered to the prism sheet 15.

### (Heat Sinks)

Each heat sink 17 is made of, for example, aluminum and has a shape of a substantial cuboid. Each heat sink 17 is arranged so that its surface on which the LED modules 12 are mounted faces the light incidence surface 101 or 102 of the light guide plate 100.

### (Control Unit)

The control unit 18 is attached to the back surface of the housing 11 and includes, for example, a large scale integrated (LSI) circuit. The control unit 18 supplies image signals to the liquid crystal panel 20, lights each LED module 12 in synchronization with the timing to supply the image signals, and controls output of each LED module 12.

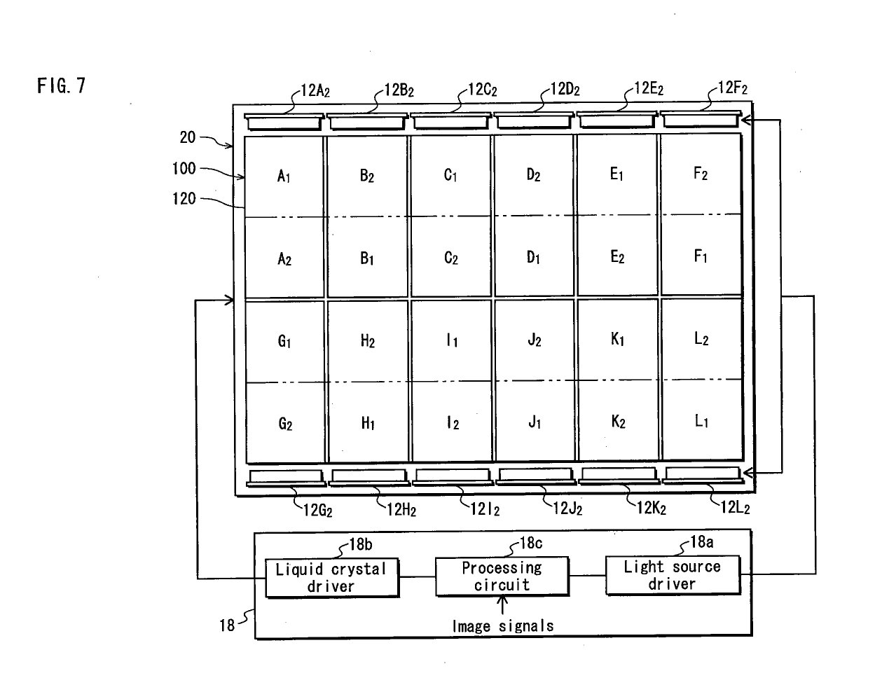

FIG. 7 is a schematic diagram illustrating the local dimming control performed by the control unit. As shown in FIG. 7, the control unit 18 includes a light source driver 18a, a liquid crystal driver 18b, and a processing circuit 18c. The light source driver 18a drives the LED modules 12. The liquid crystal driver 18b drives the liquid crystal panel 20. The processing circuit 18c processes the image signals and outputs information to the light source driver 18a and the liquid crystal driver 18b. To further expound, based on luminance information included in the image signals, the processing circuit 18c analyzes display areas that are to be displayed brightly on the liquid crystal panel 20, and inputs to the light source driver 18a light source control information for controlling the LED modules 12 so that only the emergence areas corresponding to such display areas are lit.

The processing circuit 18c stores therein, for example, pieces of partition information that each relate to a different one of the emergence areas of the light guide plate 100. The liquid crystal panel 20 is virtually partitioned into display areas that are in one-to-one correspondence with the emergence areas of the light guide plate 100 ahead of time. The processing circuit 18c also stores therein pieces of partition information that each relate to a different one of the display areas. The processing circuit 18c identifies pixels that are to be displayed brightly based on the magnitude of voltage of the image signals, and determines one or more display areas of the liquid crystal panel 20 to which the identified pixels belong. Then, the processing circuit 18c outputs to the light source driver 18a the light source control information for controlling the LED modules 12 so that only the emergence areas corresponding to the determined one or more display areas are lit. Put another way, based on the light source control information, the light source driver 18a can light the LED modules 12 corresponding to the emergence areas while adjusting light of each LED module 12 (i.e., switch between on and off of each LED module 12 while adjusting luminance of each LED module 12).

Meanwhile, the processing circuit 18c outputs the luminance information and chromaticity information included in the image signals to the liquid crystal driver 18b. The liquid crystal driver 18b drives the liquid crystal panel 20. An ordinary liquid crystal panel can be used as the liquid crystal panel 20.

Referring back to FIG. 1, the liquid crystal panel 20 includes thin-film transistors (TFTs), which function as switching elements in one-to-one correspondence with display pixels. The liquid crystal panel 20 is arranged so as to face the light emergence surface 103 of the light guide plate 100, and displays desired images based on the image signals supplied from the control unit 18.

The housing 30 includes a box-shaped body 31 having a mouth located at the front, and a stand 32 attached to the bottom surface of the body 31. The body 31 accommodates the backlight unit 10 and the liquid crystal panel 20.

### (Effects)

In the display device 1 configured in the above-described manner, the emergence areas of the light guide plate 100 are optically independent from one another. The light emitted from each of the LED modules 12, which are arranged in one-to-one correspondence with the emergence areas, emerges only from the corresponding emergence area. Accordingly, the display device 1 can light certain LED modules 12 by controlling the lighting operation with respect to each individual LED module 12. This way, certain emergence areas can be lit on an individual basis, thus enabling the local dimming control. In particular, in each of the optical members 110 and 120, there is no emergence area that neighbors other emergence areas in row and column directions. Therefore, it is rarely the case that light emerging from the target emergence area leaks to other neighboring emergence areas, and the display device 1 can realize high contrast.

Furthermore, the backlight unit 10 can control the luminous intensity for each LED module 12 in synchronization with the brightness of each area of an image to be displayed on the liquid crystal panel 20. Hence, the brightness of each emergence area can be controlled by adjusting the electric current supplied to the corresponding LED module 12 and the luminous intensity of light incident on the optical members 110 and 120. In this case, each LED module 12 is turned off upon display of a black image. This configuration can improve the contrast of an image and reduce power consumption. This configuration can also alleviate an afterimage and therefore resolve blur in video.

In addition, since the backlight unit 10 is of an edge-lit type with the LED modules 12 arranged facing the side surfaces 101 and 102 of the light guide plate 100, the backlight unit 10 can be made thinner than a direct-type backlight unit. Moreover, due to the LED modules 12 being arranged facing the side surfaces 101 and 102 of the light guide plate 100, the structure for supporting the LED modules 12 and wiring for the LED modules 12 can be omitted. With such a simple configuration, the backlight unit 10 can be made thin.

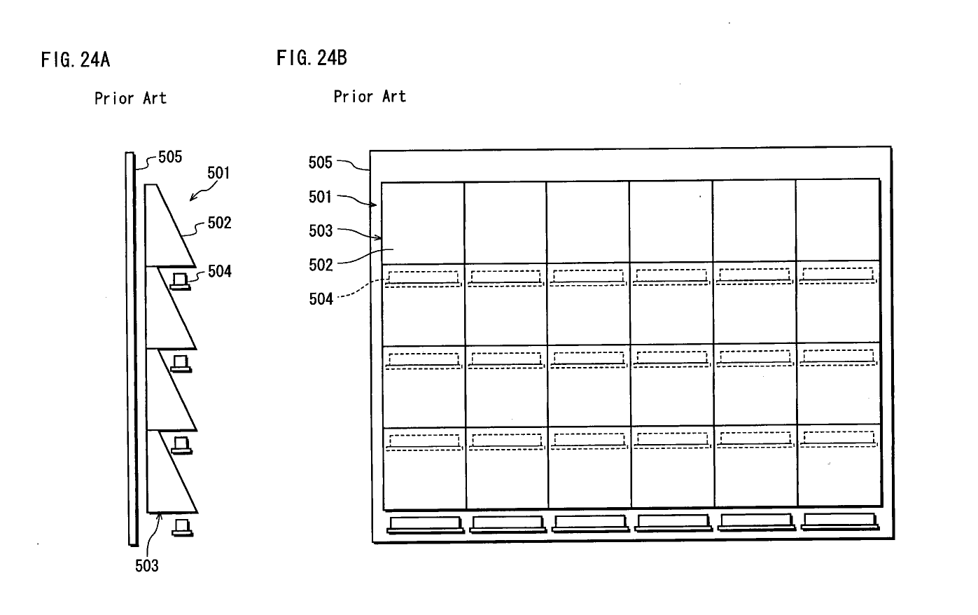

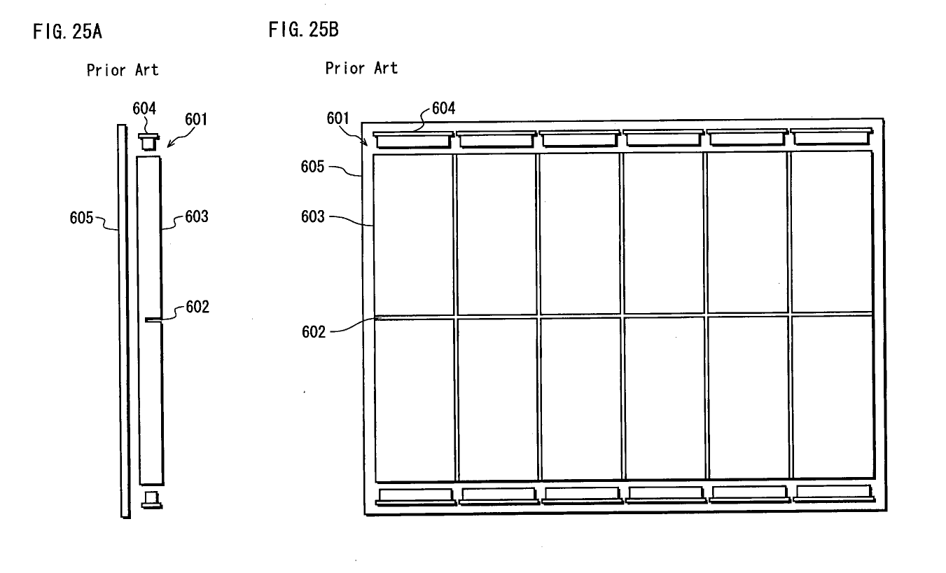

In the case of the display device pertaining to Patent Literature 1 shown in FIGS. 24A and 24B, a plurality of light sources 504 need to be arranged with some distance away from one another. This increases the number of connection points between the light sources 504 and complicates the structure of the display device, resulting in the problem that the difficulty of assembling operations is raised. In contrast, such a problem does not occur in the display device 1 pertaining to the present embodiment.

Furthermore, preferred scanning control is possible with use of the optical members pertaining to the present invention. Described below with reference to FIG. 6 are examples of such scanning control.

Assume that the following describes the case of, for example, a liquid crystal display device. A group of emergence areas in the first tier from the top, consisting of the emergence areas F₂, B₁, D₂, C₁, B₂ and A₁ (i.e., a group of emergence areas on the front main surface 111 in the first row from the top side surface 113), is considered as one partition. Here, once the rendering of a liquid crystal image is completed, the LED modules 12F₂, 12E₁, 12D₂, 12C₁, 12B₂ and 12A₁ corresponding to this group of the emergence areas F₂, E₁, D₂, C₁, B₂ and A₁ are lit all at once. Then, once the rendering of an image corresponding to this partition in the first tier is completed, control is performed so as to cause the partition in the second tier, consisting of the emergence areas F₁, E₂, D₁, C₂, B₁ and A₂, to be lit.

This way, in the optical members 110 and 120 that are each partitioned in a matrix (i.e., in row and column directions), the partitioned areas are grouped into a plurality of long quadrilateral partitions; these partitions can be parallelized and then lit in sequence. Once the rendering of a liquid crystal image is completed, by lighting these partitions one after another starting from the top tier, the video resolution can be advantageously improved.

As for the lighting order, the parallelized partitions of the optical members 110 and 120 may be subjected to the lighting control one after another. Alternatively, it is permissible to consider two partitions neighboring in a vertical direction as one group. In this case, the lighting control may be performed on each group consisting of two neighboring partitions. Alternatively, it is permissible to perform the lighting control in an overlapping manner whereby the lighting control is performed firstly on the first and second partitions from the top, secondly on the second and third partitions from the top, and so on. These types of lighting control enable scanning control together with high video resolution. Note that in order to perform the scanning control, each of the optical members 110 and 120 needs to be partitioned into two or more partitions, preferably four to ten partitions, in a column direction.

### Second Embodiment

A description is now given of an illumination device pertaining to Second Embodiment and a display device using the same.

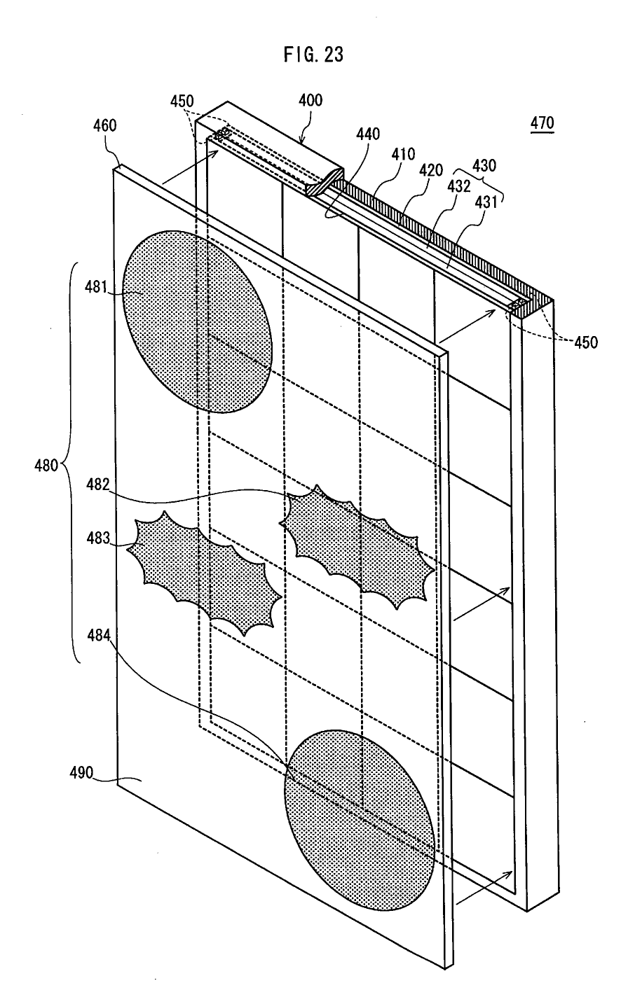

FIG. 23 is a partially cutaway perspective view showing the schematic structure of the illumination device and the display device pertaining to Second Embodiment. As shown in FIG. 23, an illumination device 400 pertaining to Second Embodiment is a plate-like base illumination source used for emergency exit signs and billboards. The illumination device 400 includes a housing 410, a reflecting plate 420, a light guide plate 430, a diffusion sheet 440, and a plurality of LED modules 450. The illumination device 400 is arranged behind a sign board 460 to illuminate the sign board 460 from behind. The illumination device 400 may be used as an illumination source solely on its own.

The housing 410 has a shape of a box. Inside the housing 410, the reflecting plate 420, the light guide plate 430 and the diffusion sheet 440 are layered in the stated order, with the reflecting plate 420 positioned on the inner bottom surface of the housing 410. Both side surfaces of the light guide plate 430 form light incidence surfaces. The plurality of LED modules 450 are arranged so as to face the side surfaces of the light guide plate 430. Light emitted from each LED module 450 is incident on the light guide plate 430 through both side surfaces thereof. Thereafter, the incident light emerges from the front surface of the light guide plate 430, is transmitted through the diffusion sheet 440 and then through the sign board 460, and finally emerges from the front surface of the sign board 460.

The light guide plate 430 is configured in a similar manner as the light guide plate 100 of First Embodiment. The light guide plate 430 includes a first optical member 431, which is the equivalent of the first optical member 110, and a second optical member 432, which is the equivalent of the second optical member 120. Each LED module 450 is controlled by a control unit (not illustrated) that is configured in a similar manner as the control unit 18 of First Embodiment. The light guide plate 430 has a plurality of emergence areas that can be lit on an individual basis. Hence, by controlling on/off of each LED module 450 and light properties of light emitted therefrom (e.g., contrast, a color temperature, and a color of emitted light), only certain areas of the sign board 460 can be illuminated in a different manner from other areas of the sign board 460. Accordingly, such a combination of the illumination device 400 and the sign board 460 gives rise to a billboard having great visual effects.

For example, the sign board 460 has a first sign region 480 consisting of areas 481 through 484 and a second sign region 490 that is other than the first sign region 480. A certain type of advertisement is displayed on the first sign region 480, whereas another different type of advertisement is displayed on the second sign region 490. By the control unit lighting each LED module 450 while adjusting light emitted therefrom in accordance with the respective sign areas 480 and 490, illumination on the first sign region 480 and illumination on the second sign region 490 can be alternated, with the result that two different types of advertisement are alternately displayed. At this time, if the control unit further performs lighting control that makes additional changes to the lighting state of each LED module 450, then the external appearance of the sign board 460 can change to a greater extent. This gives rise to a billboard that can easily attract more attention.

In the illumination device pertaining to the present invention, light sources are properly arranged so as to face the side surfaces in correspondence with the emergence areas. Here, one or more of the light sources may have a different color temperature from the rest of the light sources. With this configuration, the illumination device can arbitrarily switch between or mix two or more types of color temperatures. For example, assume that the illumination device pertaining to the present embodiment is configured using two types of light sources that have different color temperatures from each other (3000 K and 10000 K). In this case, the color temperature of the illumination device can be controlled to range from 3000 K to 10000 K by adjusting light of each light source. In order to make the illumination device suitable for general lighting commonly used in general households, the illumination device should be provided with light sources that enable a color temperature ranging approximately from 5000 K to 7000 K when fully lit, and should utilize these light sources as necessary.

The illumination device pertaining to the present invention may be implemented according to other embodiments. One example of other embodiments is such that the light emergence surface of the light guide plate is partitioned into (i) areas provided with prism sheets for light focus, and (ii) areas provided with diffusion sheets for light diffusion. In this example, when light sources to be lit are properly selected, it is possible to arbitrarily select one of the following two types of light distribution pattern: light focus and light diffusion. Furthermore, by adjusting light of each light source, it is possible to select a light distribution pattern realizing a cross between light focus and light diffusion. An illumination device having such configuration is highly flexible. Alternatively, it is permissible to provide a plurality of (e.g., two) areas on the light emergence surface of the light guide plate with a plurality of (e.g., two) prism sheets, respectively, in such a manner that the directions in which the prism sheets focus lights differ (e.g., by 90 degrees). This allows the illumination device to change the direction of light focus. It is also permissible to provide double-layered prism sheets in order to enhance the extent of light focus.

The above configuration examples are applicable both to a case where the illumination device is used as a plate-like base illumination source for emergency exit signs and billboards, and to a case where the illumination device is used as an illumination source solely on its own.

### Modification Examples

The backlight unit and display device pertaining to the present invention have been specifically described above based on the embodiments. However, the contents of the present invention are not limited to the above embodiments. For instance, the following modification examples are possible.

### <Light Sources>

The light sources are not limited to LED modules. Alternatively, for example, the light sources may be light emitting modules using semiconductor light emitting elements such as laser diodes (LDs) and organic electroluminescence (OEL), or may be lamps such as cold cathode discharge lamps and hot cathode discharge lamps.

### <Reflecting Sheets>

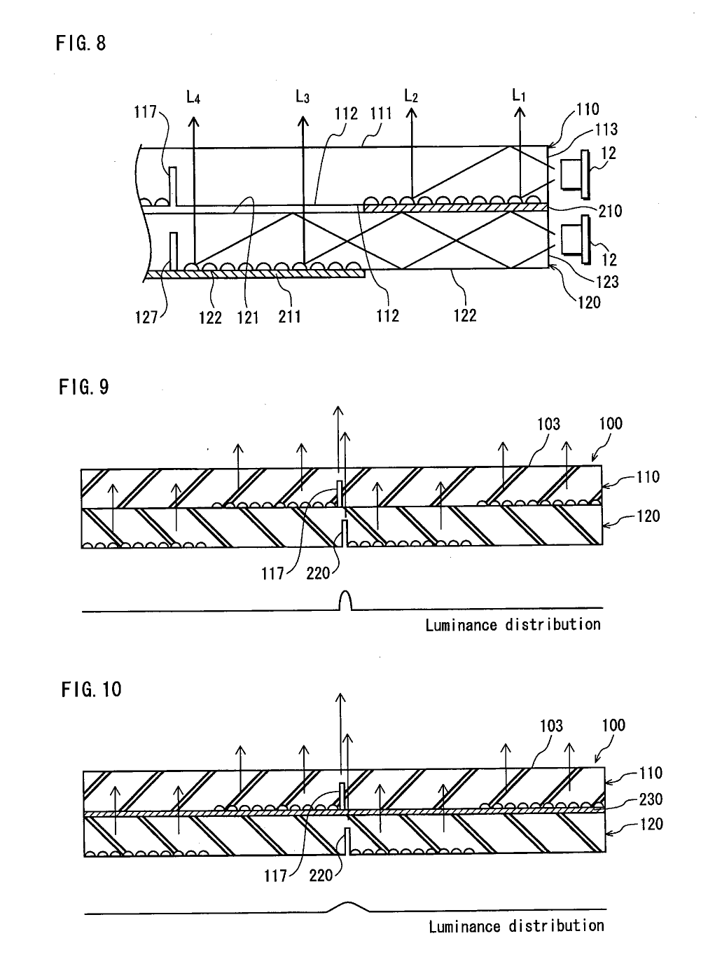

Reflecting sheets may be arranged on areas of the back main surfaces of the optical members that correspond to the emergence areas. FIG. 8 is a schematic diagram showing a modification example in which the reflecting sheets are arranged on areas that oppose the emergence areas. In the modification example shown in FIG. 8, reflecting sheets 210 are arranged on areas of the back main surface 112 of the first optical member 110 that oppose the emergence areas. This configuration can prevent a situation where parts of the light scattered by the dotted patterns, which are formed in areas of the back main surface 112 opposing the emergence areas, emerge from the back main surface 112 toward the outside of the first optical member 110 and are consequently incident on the second optical member 120. This configuration also allows such parts of the light scattered by the dotted patterns to reflect off the reflecting sheets 210 and to emerge from the emergence areas of the front main surface 111.

Similarly, in the modification example shown in FIG. 8, reflecting plates 211 are arranged only on areas of the back main surface 122 of the second optical member 120 that oppose the emergence areas. This configuration can make an area of all the arranged reflecting plates 211 smaller than an area of the reflecting plate 13 of the above embodiments which is arranged on an entirety of the back main surface 122 of the second optical member 120. As a result, the costs required for the components can be reduced.

### <Grooves>

The grooves on the optical members may be formed so that when viewing the light guide plate while facing the light emergence surface thereof, the grooves do not overlap one another. FIG. 9 is a schematic diagram showing a modification example in which the grooves do not overlap one another. In the modification example shown in FIG. 9, grooves 220 are formed on the second optical member 120 so that when viewing the light guide plate 100 while facing the light emergence surface 103, each of the grooves 220 does not overlap any of the grooves 117 formed on the first optical member 110. This configuration evens out the high luminance caused by the grooves 117 and 127 as compared to the case where each of the grooves 117 on the first optical member 110 overlaps a different one of the grooves 127 on the second optical member 120 as described in the above embodiments. Accordingly, this configuration can narrow the gap between luminance of light from areas where the grooves 117 and 127 are formed and luminance of light from areas where the grooves 117 and 127 are not formed.

A diffusion sheet may be arranged between the optical members. FIG. 10 is a schematic diagram showing a modification example in which a diffusion sheet is arranged between the optical members. In the modification example shown in FIG. 10, a diffusion sheet 230 is arranged between the first optical member 110 and the second optical member 120. This configuration can diffuse light emerging from the second optical member 120, thus narrowing the gap between levels of luminance caused by the grooves 220. Furthermore, by combining this configuration with the above-described configuration in which the grooves 117 and 127 are formed so as not to overlap one another, the gap between levels of luminance caused by the grooves 220 can be narrowed to a greater extent.

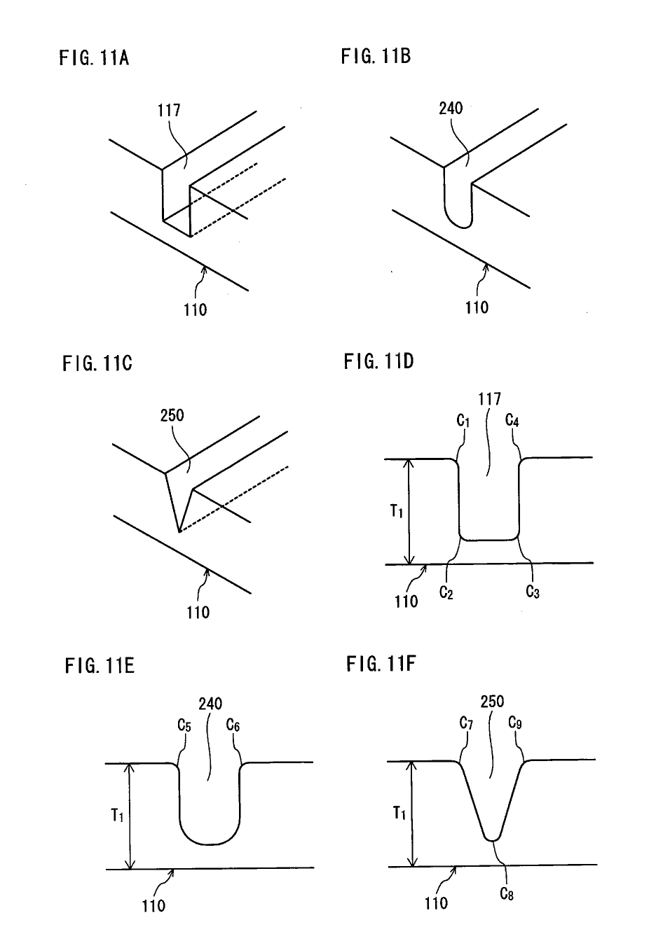

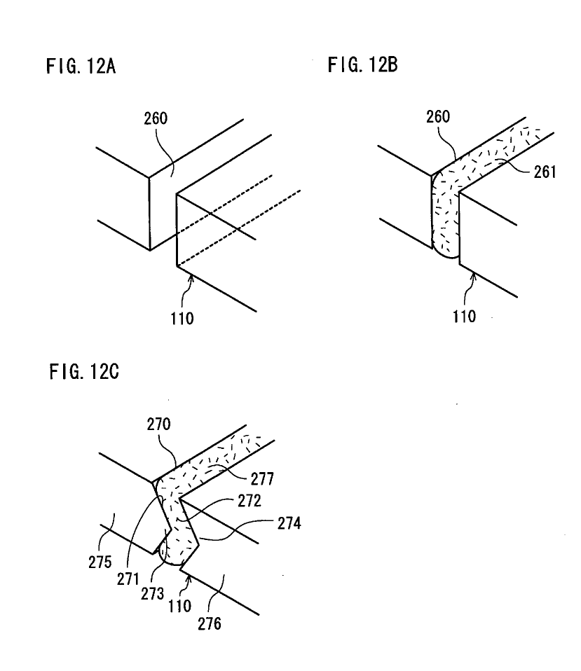

The following describes shapes of the grooves by using an example of the first optical member 110. FIGS. 11A to 11F and 12A to 12C are perspective views illustrating shapes of the grooves. In the above embodiments, each groove 117 has a substantially rectangular cross-section as shown in FIG. 11A. However, each groove 117 is not limited to having such a substantially rectangular cross-section. For example, as shown in FIG. 11B, a cross-section of each groove 240 may have a shape of a substantial horseshoe. Alternatively, as shown in FIG. 11C, a cross-section of each groove 250 may have a shape of a substantial wedge.

It should be noted that the above-described cross-sections of the grooves 117, 240 and 250 denote cutaway planes that can be observed when cutting the optical member 110 along a thickness direction thereof, with a surface of the optical member 110 close to the liquid crystal panel 20 considered as a top surface. As such, the grooves are not limited to having particular shapes. However, in order to further suppress light leakage, it is preferable that cross-sections of the grooves include no acute angle as shown in FIGS. 11D to 11F. It is more preferable that in cross-sections of the grooves, each corner (C₁ to C₉) of the grooves have a curvature R. When a cross-section of a groove includes an acute angle, a large amount of light emerges from the vertex of the acute angle, thus rendering the luminance of such light high. Consequently, the levels of luminance of light from the grooves become uneven. Here, provided that the optical member 110 has a thickness T₁ (mm), in order to improve reflectivity of the grooves and further suppress light leakage, each corner of the grooves preferably has a curvature in a range of 0.1T₁ to 2T₁ inclusive in cross-sections of the grooves. Furthermore, the grooves are not limited to being formed in particular positions. The grooves may be formed on the front surface or the back surface of the optical member 110. It should be noted that in the present embodiment, the front surface of the optical member 110 denotes a surface that is close to the liquid crystal panel 20, provided that the optical member 110 is one of constituent elements of the display device 1.

Alternatively, as shown in FIG. 12A, grooves 260 may penetrate through the optical member 110 in a thickness direction of the optical member 110. With this configuration, two neighboring areas with a groove 260 positioned therebetween can be optically separated from each other in a more reliable manner. Alternatively, as shown in FIG. 12B, a light diffusing member 261 may be provided inside each groove 260. This configuration can not only narrow the gap between luminance of light from areas where the grooves 260 are formed and luminance of light from areas where the grooves 260 are not formed, but also optically separate two neighboring areas with a groove 260 positioned therebetween from each other in a more reliable manner.

Alternatively, as shown in FIG. 12C, fitting portions 273 and 274 may be formed in opposing side surfaces 271 and 272 of each groove 270. In a case where each groove 270 penetrates through the optical member 110 in the thickness direction of the optical member 110 and extends all the way between opposing side surfaces of the optical member 110 (i.e., between the top side surface 113 and the bottom side surface 114, or between the right side surface 115 and the left side surface 116), two areas of the optical member 110 that are neighboring with a groove 270 positioned therebetween can be separated from each other as individual components 275 and 276. This configuration makes it easy to assemble these individual components 275 and 276 in completing the optical member 110. Furthermore, when assembling the individual components 275 and 276 in the above-described manner, they can be adhered to each other by filling each groove 270 with an adhesive 277. At this time, light diffusing materials may be included in the adhesive 277 so as to allow the adhesive 277 to function as a light diffusing member. This configuration can narrow the gap between luminance of light from areas where the grooves 270 are formed and luminance of light from areas where the grooves 270 are not formed.

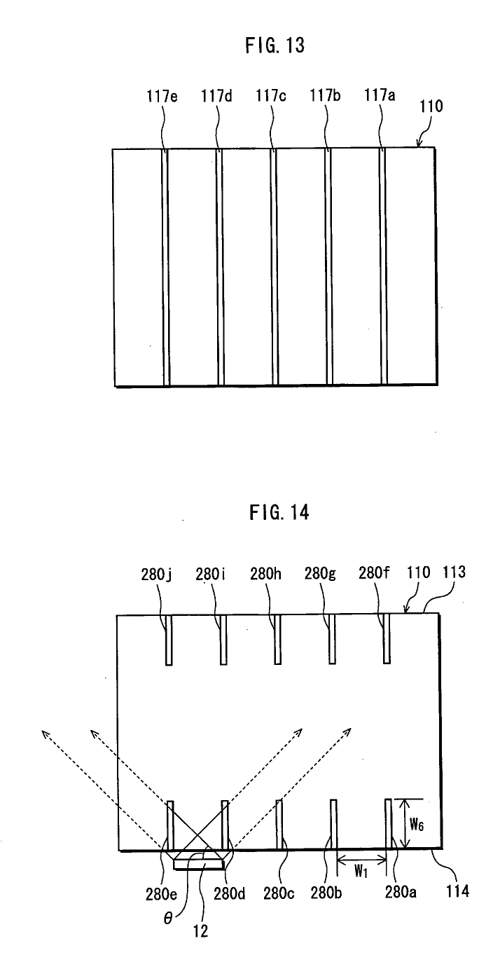

The following describes the positions in which the grooves are formed using an example of the first optical member 110. Although it is preferable to form the grooves in order to optically separate the areas from one another, the grooves are not necessarily required. FIGS. 13 to 16 are schematic diagrams showing modification examples of the positions in which the grooves are formed.

It is efficient to form grooves 117a to 117e extending in a column direction in order to separate rays of light emitted from LED modules 12 that are neighboring along a row direction and to prevent light leakage between two areas that are neighboring along the row direction. By way of example, this design can be implemented in the following manner: as per the modification example shown in FIG. 13, the grooves 117a to 117e are formed extending only along the column direction, and no groove is formed at all extending in the row direction. However, it should be noted that when one or more grooves are formed extending in the row direction, rays of light emitted from two opposing LED modules 12 can be separated from each other, and light leakage between two areas that are neighboring in the column direction can be prevented as well.

Meanwhile, in the modification example shown in FIG. 14, grooves 281a to 281e each having a predetermined length W₆ are formed on the optical member 110 so as to extend from the bottom side surface 114 toward the top side surface 113. Similarly, grooves 281f to 281j each having the same predetermined length W₆ as the grooves 281a to 281e are formed on the optical member 110 so as to extend from the top side surface 113 toward the bottom side surface 114. The length W₆ of each of the grooves 281a to 281j is substantially the same as a gap between any two neighboring grooves among all the grooves 281a to 281j (this gap is equivalent to the row-direction width W₁ of each of rectangular regions partitioned by the grooves 117a to 117f as shown in FIG. 3). This configuration can effectively prevent the light that is emitted from one or more of the LED modules 12 at an emission angle θ of approximately 45 degrees and that has the highest luminance from being incident on other areas neighboring in the row direction.

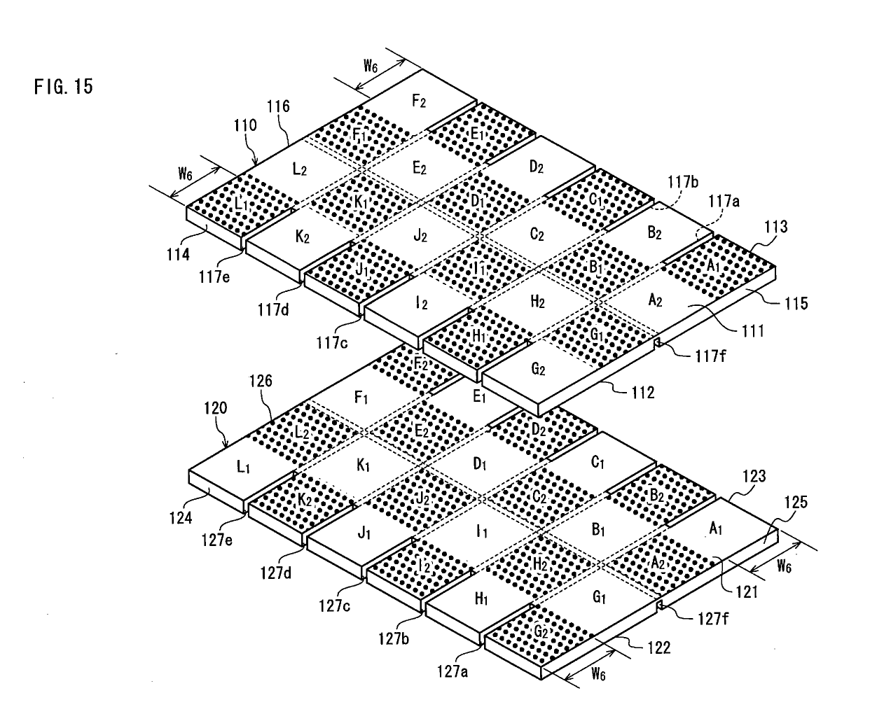

The above modification examples may be put into practical use in the following manner as one example. As shown in FIG. 15, the grooves 117a to 117e (127a to 127e) extending in a column direction are formed on the optical member 110 (120) pertaining to the above embodiments. Here, parts of these grooves may penetrate through the optical member 110 (120) in a thickness direction of the optical member 110 (120), each part having the predetermined length W₆ and extending from the top side surface 113 (123) toward the bottom side surface 114 (124), or from the bottom side surface 114 (124) toward the top side surface 113 (123).

In the above embodiments, the five grooves 117a to 117e (127a to 127e) are formed on the optical member 110 (120) so as to extend in the column direction, namely a direction perpendicular to the top side surface 113 (123), all the way from the top side surface 113 (123) to the bottom side surface 114 (124) opposing the top side surface 113 (123). The five grooves 117a to 117e (127a to 127e) extending all the way from the top side surface 113 (123) to the bottom side surface 114 (124) do not penetrate through the optical member 110 (120) in the thickness direction thereof, not even partially. In other words, the optical member 110 (120) includes connecting portions each connecting between two neighboring areas. As opposed to the above embodiments, the present modification example suggests a structure in which parts of the grooves 117a to 117e (127a to 127e) each having the predetermined length W₆ penetrate through the optical member 110 (120) in the thickness direction thereof, whereas the remaining parts of the grooves 117a to 117e (127a to 127e) do not penetrate through the optical member 110 (120) in the thickness direction thereof—i.e., the optical member 110 (120) includes connecting portions each connecting between two neighboring areas.

With the above configuration, the stated parts of the grooves 117a to 117e (127a to 127e), each of which has the predetermined length W₆ and penetrates through the optical member 110 (120) in the thickness direction thereof, can effectively prevent the light that is emitted from one or more of the LED modules 12 at an emission angle θ of approximately 45 degrees and that has the highest luminance from being incident on other areas neighboring in the row direction. At the same time, beneath the remaining parts of the grooves 117a to 117e (127a to 127e), the optical member 110 (120) includes connecting portions each connecting between two neighboring areas. This can suppress reduction in the strength of the optical member 110 (120).

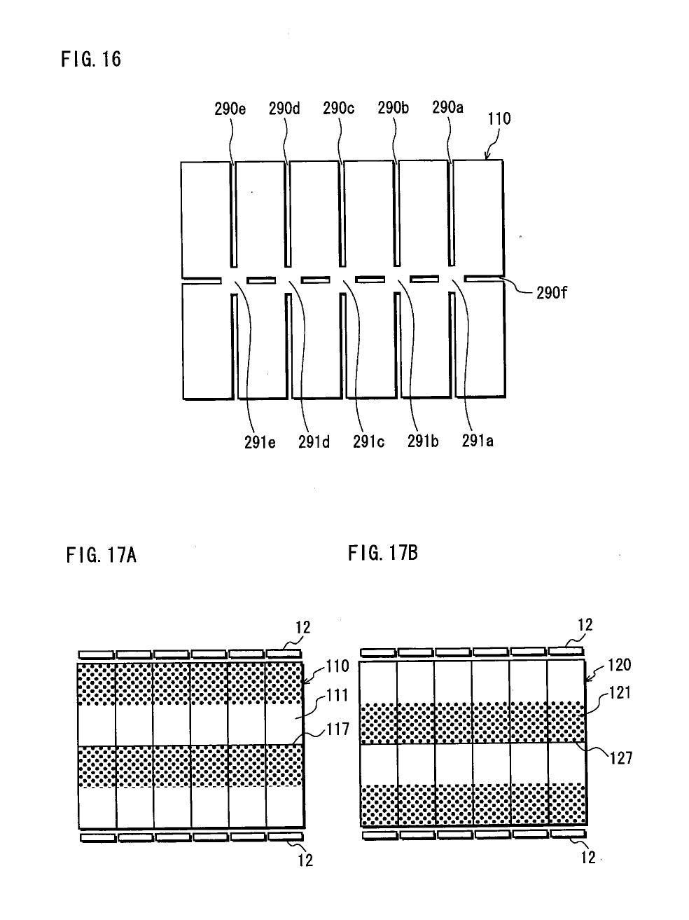

FIG. 16 shows another modification example in which grooves 290a to 290f are not formed so as to extend all the way in the row and column directions. More specifically, each of the grooves 290a to 290e consists of two grooves that are coaxially aligned and separated from each another with one of portions 291a to 291e therebetween, and the groove 290f consists of multiple grooves that are coaxially aligned and separated from one another with the portions 291a to 291e therebetween. In a case where the grooves 290a to 290f penetrate through the optical member 110 in the thickness direction thereof, the above configuration can prevent the optical member 110 from being separated into a plurality of components.

### <Optical Members>

One or more grooves may be formed arbitrarily on at least one of the front main surface and the back main surface of each optical member so as to extend along a main travelling direction of light (i.e., a direction perpendicular to the light incidence surfaces of the light guide plate—namely, the column direction). As one example, one or more grooves each having a substantially triangular or trapezoidal cross-section may be formed arbitrarily on both of the entire front main surface 111 (121) and the entire back main surface 112 (122) of the optical member 110 (120) so as to extend in a main travelling direction of light. This configuration enables more suitable control on the light diffusing performance or the light focusing performance by the optical members. In addition, by properly selecting the shape, depth, and the like of each groove, properties of light to travel in a straight line (the degree at which light travels in a straight line inside the optical members without spreading) can be adjusted.

It should be noted that one or more grooves formed on at least one of the front main surface and the back main surface of each optical member are not limited to extending along the main travelling direction of light. Furthermore, in a case where one or more grooves are formed on both of the front main surface and the back main surface of each optical member, it is not necessarily required for the grooves on the front main surface and the grooves on the back main surface to be symmetric.

Therefore, the following exemplary configuration is possible: one or more grooves each having a substantially trapezoidal cross-section are formed on the entire front main surface 111 (121), so as to extend in the main travelling direction of light, whereas a groove having a substantially triangular cross-section is formed only on each of the areas on the back main surface 112 (122) corresponding to the emergence areas, so as to extend in a direction perpendicular to the main travelling direction of light (i.e., a direction parallel to the light incidence surfaces of the light guide plate—namely, the row direction). The above configuration allows light to emerge from the front main surface 111 (121) while preserving properties of the light to travel in a straight line to a great extent. As a result, when performing the local dimming, high luminance contrast can be achieved in a border between a lit area and an unlit area neighboring each other. This can not only save energy consumed by the backlight unit and illumination device, but also provide images with high contrast when the backlight unit and illumination device are used for, for example, a TV or the like. It should be noted that the grooves can be formed by using any of the commonly known methods (e.g., injection molding).

### <Light Guide Plate>

It is not necessarily required for the emergence areas and non-emergence areas to be arranged in a checkerboard pattern on each optical member. FIGS. 17A to 19B are schematic diagrams showing modification examples of arrangements of emergence areas and non-emergence areas. To be more specific, FIGS. 17A, 18A and 19A are plan views each showing the first optical member, whereas FIGS. 17B, 18B and 19B are plan views each showing the second optical member. In each of FIGS. 17A to 19B, hatched areas and non-hatched areas on the front main surface 111 (121) of the optical member 110 (120) represent emergence areas and non-emergence areas, respectively.

For example, as shown in FIGS. 17A and 17B, emergence areas and non-emergence areas may be arranged so as to make a stripe pattern with each stripe extending in a row direction. This arrangement can effectively prevent light leakage between two areas neighboring in a column direction.

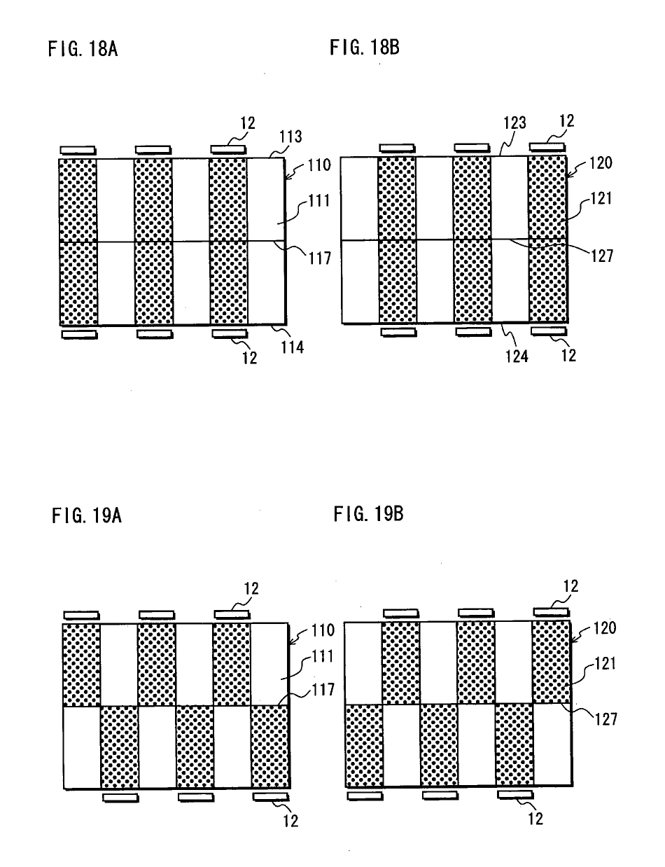

Alternatively, as shown in FIGS. 18A and 18B, emergence areas and non-emergence areas may be arranged so as to make a stripe pattern with each stripe extending in a column direction. This arrangement can effectively prevent light leakage between two areas neighboring in a row direction. Furthermore, with this arrangement, some portions of the optical member 110 (120) include no emergence area at all from the top side surface 113 (123) through to the bottom side surface 114 (124). Since there is no need to arrange the LED modules 12 in correspondence with such portions, the number of LED modules 12 to be ultimately arranged can be reduced in half.

Alternatively, as shown in FIGS. 19A and 19B, the front main surface 111 (121) of the optical member 110 (120) may be partitioned into rectangular regions by grooves 117 (127), with each rectangular region consisting of a group of emergence areas or a group of non-emergence areas. With this arrangement, every one of emergence areas and non-emergence areas is partitioned by the grooves 117 or 127. Accordingly, light leakage can be prevented to a greater extent. Furthermore, with this arrangement, there is no need to arrange the LED modules 12 in correspondence with rectangular regions consisting of non-emergence areas. Accordingly, the number of LED modules 12 to be ultimately arranged can be reduced in half.

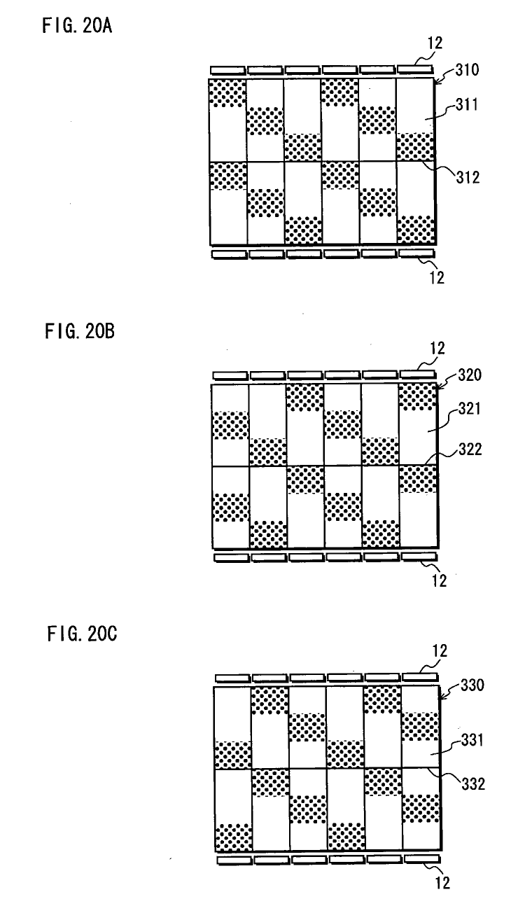

The number of optical members is not necessarily limited to two, but may be three or more. FIGS. 20A to 20C are schematic diagrams showing a modification example of a light guide plate including three optical members. To be more specific, FIG. 20A is a plan view showing a first optical member, FIG. 20B is a plan view showing a second optical member, and FIG. 20C is a plan view showing a third optical member. In each of FIGS. 20A to 20C, hatched areas and non-hatched areas on the front main surfaces 311, 321 and 331 of the optical members 310, 320 and 330 represent emergence areas and non-emergence areas, respectively. Also, in each of FIGS. 20A to 20C, the solid lines on the front main surfaces 311, 321 and 331 represent positions in which the grooves 312, 322 and 332 are formed.

For example, as shown in FIGS. 20A to 20C, the light guide plate may be formed by layering the three optical members 310, 320 and 330 in a thickness direction of the optical members 310, 320 and 330. This configuration increases the number of areas for which light adjustment control can be performed. In particular, this configuration increases the number of such areas in a column direction.

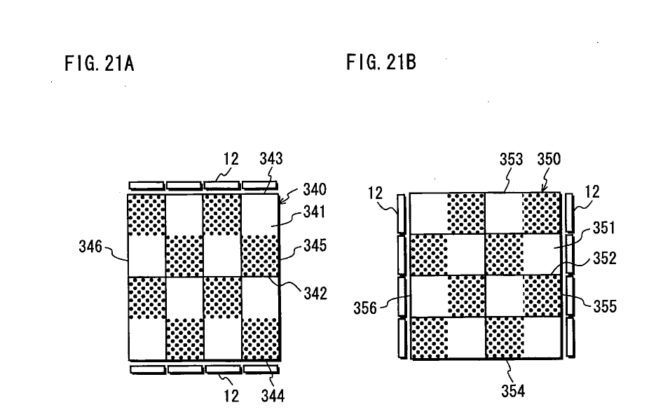

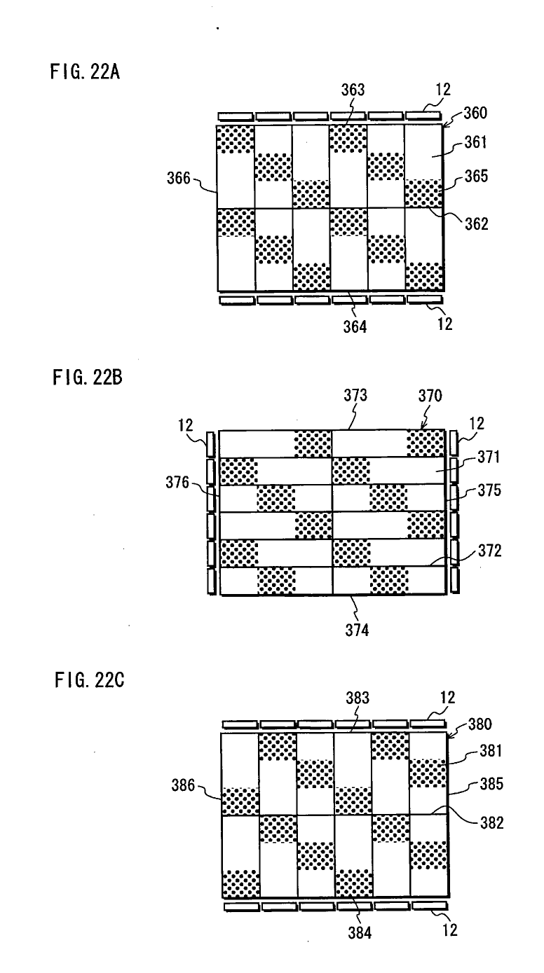

It is not necessarily required for a light incidence surface of one optical member to face the same direction as a corresponding light incidence surface of another optical member. FIGS. 21A to 22C are schematic diagrams each showing a modification example applicable to a case where the direction that a light incidence surface faces differs from one optical member to another. To be more specific, FIGS. 21A and 22A are plan views each showing a first optical member; FIGS. 21B and 22B are plan views each showing a second optical member; and FIG. 22C is a plan view showing a third optical member. In each of FIGS. 21A to 22C, hatched areas and non-hatched areas on the front main surfaces 341, 351, 361, 371 and 381 of the optical members 340, 350, 360, 370 and 380 represent emergence areas and non-emergence areas, respectively. Also, in each of FIGS. 21A to 22C, the solid lines on the front main surfaces 341, 351, 361, 371 and 381 represent positions in which the grooves 342, 352, 362, 372, and 382 are formed.

Assume that a light guide plate is formed by layering two optical members in a thickness direction thereof. In this case, as shown in FIG. 21A, a top side surface 343 and a bottom side surface 344 of the first optical member 340 are light incidence surfaces, and a right side surface 345 and a left side surface 346 of the same are light reflecting surfaces. In contrast, as shown in FIG. 21B, a top side surface 353 and a bottom side surface 354 of the second optical member 350 are light reflecting surfaces, and a right side surface 355 and a left side surface 356 of the same are light incidence surfaces. This configuration can prevent light emitted from the LED modules 12 that are arranged so as to face the light incidence surfaces of the first optical member 340 from being incident on the light incidence surfaces of the second optical member 350. This configuration can also prevent light emitted from the LED modules 12 that are arranged so as to face the light incidence surfaces of the second optical member 350 from being incident on the light incidence surfaces of the first optical member 340.

On the other hand, assume that a light guide plate is formed by layering three optical members in a thickness direction thereof. In this case, as shown in FIG. 22A, a top side surface 363 and a bottom side surface 364 of the first optical member 360 are light incidence surfaces, and a right side surface 365 and a left side surface 366 of the same are light reflecting surfaces. Similarly, as shown in FIG. 22C, a top side surface 383 and a bottom side surface 384 of the third optical member 380 are light incidence surfaces, and a right side surface 385 and a left side surface 386 of the same are light reflecting surfaces. In contrast, as shown in FIG. 22B, a top side surface 373 and a bottom side surface 374 of the second optical member 370 are light reflecting surfaces, and a right side surface 375 and a left side surface 376 of the same are light incidence surfaces. This configuration can prevent light emitted from the LED modules 12 that are arranged so as to face the light incidence surfaces of the first and third optical members 360 and 380 from being incident on the light incidence surfaces of the second optical member 370. This configuration can also prevent light emitted from the LED modules 12 that are arranged so as to face the light incidence surfaces of the second optical member 370 from being incident on the light incidence surfaces of the first and third optical members 360 and 380.

### INDUSTRIAL APPLICABILITY

A display device pertaining to the present invention is suitable for use as, for example, a television receiver. When the display device pertaining to the present invention is used as a television receiver, it offers a wide dynamic range due to high contrast, and rarely causes blur in video due to an alleviated afterimage. As such, the display device pertaining to the present invention can perform display with high image quality and sharpness overall.

### REFERENCE SIGNS LIST

1, 470 display device

10 backlight unit

12, 450 light source

18 control unit

20 liquid crystal panel

100, 430 light guide plate

101, 102 side surface

103 main surface

110, 120, 431, 432 optical member

113, 114, 123, 124 light incidence surface

117, 127 groove

210, 211 reflecting sheet

230 diffusion sheet

261, 277 light diffusing member

400 illumination device

460 sign board

480, 490 sign region

1. A backlight unit including a light guide plate and a plurality of light sources, wherein
the light guide plate includes a plurality of layered plate-like optical members,
a main surface of each optical member is partitioned into a plurality of areas that include one or more emergence areas and one or more non-emergence areas,
when light is incident on each optical member through a side surface thereof, the incident light emerges from the emergence areas of the optical member but does not emerge from any of the non-emergence areas of the optical member,
the optical members are layered in such a manner that each non-emergence area of one of the optical members overlaps a different one of the emergence areas of another optical member, and
the light sources are arranged so as to face the side surface of each optical member and are capable of local dimming control by being lit with light emitted therefrom adjusted.

2. The backlight unit of claim 1, wherein
on the main surface of each optical member, the number of the emergence areas and the number of the non-emergence areas are more than one each, and the emergence areas and the non-emergence areas are arranged in a checkerboard pattern.

3. The backlight unit of claim 1, wherein
on each optical member, a groove is provided in at least part of positions corresponding to borders each lying between one of the emergence areas and one of the non-emergence areas neighboring each other.

4. The backlight unit of claim 3, wherein
on each optical member, the groove extends in a direction perpendicular to the side surface, from the side surface through to another side surface of the optical member opposite thereto.

5. The backlight unit of claim 3, wherein
when viewing the light guide plate while facing a main surface thereof, the groove on one of the optical members does not overlap the groove on another optical member.

6. The backlight unit of claim 3, wherein
a ratio of a depth T2 of the groove to a thickness T1 of each optical member, namely T2/T1, satisfies the following relationship: 0.5≦T2/T1≦0.95.

7. The backlight unit of claim 3, wherein
the groove penetrates through each optical member in a thickness direction of the optical member.

8. The backlight unit of claim 3, wherein
a light diffusing member is provided in the groove of each optical member.

9. The backlight unit of claim 1, wherein
on a surface of each optical member opposite to the main surface thereof, a reflecting sheet is arranged in each of areas opposing the emergence areas.

10. The backlight unit of claim 1, wherein
a diffusion sheet is arranged between each pair of the optical members.

11. A backlight unit comprising
a light guide plate that includes a plurality of plate-like optical members layered in a thickness direction of the optical members and that has (i) one or more side surfaces through which light is incident on the light guide plate and (ii) a main surface from which the incident light emerges, wherein
side surfaces of the optical members constituting the one or more side surfaces of the light guide plate are light incident surfaces through which the light is incident on the optical members,
a plurality of light sources are arranged so as to face the light incident surfaces,
a main surface of each optical member that either constitutes the main surface of the light guide plate or is closer to the main surface of the light guide plate than any other surfaces of the optical member includes one or more emergence areas and one or more non-emergence areas,
light emitted from the light sources and incident on the optical members through the light incident surfaces emerges from the emergence areas but does not emerge from any of the non-emergence areas, and
when viewing the light guide plate while facing the main surface thereof, each emergence area of one of the optical members does not overlap any of the emergence areas of another optical member, and each non-emergence area of one of the optical members overlaps a different one of the emergence areas of another optical member.

12. A display device comprising:
the backlight unit of claim 1;
a liquid crystal panel illuminated by the backlight unit; and
a control unit configured to supply image signals to the liquid crystal panel and to light one or more of the light sources in accordance with one or more positions on a screen and luminance of each position, which are indicated by the image signals, while adjusting light emitted from the one or more of the light sources in synchronization with a timing to display an image.

13. A display device comprising:
the backlight unit of claim 11;
a liquid crystal panel illuminated by the backlight unit; and
a control unit configured to supply image signals to the liquid crystal panel and to light one or more of the light sources in accordance with one or more positions on a screen and luminance of each position, which are indicated by the image signals, while adjusting light emitted from the one or more of the light sources in synchronization with a timing to display an image.

14. An illumination device including a light guide plate and a plurality of light sources, wherein
the light guide plate includes a plurality of layered plate-like optical members,
a main surface of each optical member is partitioned into a plurality of areas that include one or more emergence areas and one or more non-emergence areas,
when light is incident on each optical member through a side surface thereof, the incident light emerges from the emergence areas of the optical member but does not emerge from any of the non-emergence areas of the optical member,
the optical members are layered in such a manner that each non-emergence area of one of the optical members overlaps a different one of the emergence areas of another optical member, and
the light sources are arranged so as to face the side surface of each optical member.

15. The illumination device of claim 14, wherein
the light sources, which are arranged so as to face the side surface of each optical member, are capable of local dimming control by being lit with light emitted therefrom adjusted.

16. An illumination device comprising
a light guide plate that includes a plurality of plate-like optical members layered in a thickness direction of the optical members and that has (i) one or more side surfaces through which light is incident on the light guide plate and (ii) a main surface from which the incident light emerges, wherein
side surfaces of the optical members constituting the one or more side surfaces of the light guide plate are light incident surfaces through which the light is incident on the optical members,
a plurality of light sources are arranged so as to face the light incident surfaces,
a main surface of each optical member that either constitutes the main surface of the light guide plate or is closer to the main surface of the light guide plate than any other surfaces of the optical member includes one or more emergence areas and one or more non-emergence areas,
light emitted from the light sources and incident on the optical members through the light incident surfaces emerges from the emergence areas but does not emerge from any of the non-emergence areas, and
when viewing the light guide plate while facing the main surface thereof, each emergence area of one of the optical members does not overlap any of the emergence areas of another optical member, and each non-emergence area of one of the optical members overlaps a different one of the emergence areas of another optical member.

17. A display device comprising:
the illumination device of claim 14;
a sign board that includes a plurality of sign regions and is illuminated by the illumination device; and
a control unit configured to light one or more of the light sources in accordance with the sign regions.

18. A display device comprising:
the illumination device of claim 16;
a sign board that includes a plurality of sign regions and is illuminated by the illumination device; and
a control unit configured to light one or more of the light sources in accordance with the sign regions.
